(19) United States
(12) Patent Application Publication
(10) Pub. No.: US 2025/0381982 A1
(43) Pub. Date: Dec. 18, 2025

(54) ATTENTION-BASED ANOMALY DETECTION

(71) Applicant: Mobileye Vision Technologies Ltd., Jerusalem (IL)

(72) Inventor: Roy Maor LOTAN, Caesarea (IL)

(73) Assignee: Mobileye Vision Technologies Ltd., Jerusalem (IL)

(21) Appl. No.: 19/233,145

(22) Filed: Jun. 10, 2025

Related U.S. Application Data
(60) Provisional application No. 63/659,534, filed on Jun. 13, 2024.
(60) Provisional application No. 63/771,140, filed on Mar. 13, 2025.

(51) Int. Cl. B60W 60/00; B60W 50/14; G06V 20/58

(52) U.S. Cl. CPC B60W 60/001; B60W 50/14; G06V 20/582; B60W 2050/143; B60W 2050/146; B60W 2552/00

(57) ABSTRACT

A system for navigating a host vehicle relative to a road segment includes: at least one processor comprising circuitry and a memory, wherein the memory includes instructions that when executed by the circuitry cause the at least one processor to: receive a captured image acquired by a camera onboard the host vehicle; generate a representation in embedding space of at least a portion of the captured image; determine whether the representation in embedding space of the at least a portion of the captured image falls outside of a predetermined embedding space region, wherein the predetermined embedding space region is defined as a non-anomalous embedding space region; determine a navigational action for the host vehicle based on a determination that the representation in embedding space of the at least a portion of the captured image falls outside of the predetermined embedding space region; and cause at least one system associated with the host vehicle to implement the navigational action.

### CROSS-REFERENCES TO RELATED APPLICATIONS

This application claims the benefit of priority to U.S. Provisional Patent Application No. 63/659,534, filed on Jun. 13, 2024; and U.S. Provisional Patent Application No. 63/771,140, filed on Mar. 13, 2025. The entire contents of the foregoing are incorporated by reference in their entireties.

### BACKGROUND

### Technical Field

The present disclosure relates generally to autonomous vehicle navigation.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). At the same time, in order to navigate to a destination, an autonomous vehicle may also need to identify its location within a particular roadway (e.g., a specific lane within a multi-lane road), navigate alongside other vehicles, avoid obstacles and pedestrians, observe traffic signals and signs, and travel from one road to another road at appropriate intersections or interchanges. Harnessing and interpreting vast volumes of information collected by an autonomous vehicle as the vehicle travels to its destination poses a multitude of design challenges. The sheer quantity of data (e.g., captured image data, map data, GPS data, sensor data, etc.) that an autonomous vehicle may need to analyze, access, and/or store poses challenges that can in fact limit or even adversely affect autonomous navigation. Furthermore, if an autonomous vehicle relies on traditional mapping technology to navigate, the sheer volume of data needed to store and update the map poses daunting challenges.

### SUMMARY

A system for navigating a host vehicle relative to a road segment includes: at least one processor comprising circuitry and a memory, wherein the memory includes instructions that when executed by the circuitry cause the at least one processor to: receive a captured image acquired by a camera onboard the host vehicle; generate a representation in embedding space of at least a portion of the captured image; determine whether the representation in embedding space of the at least a portion of the captured image falls outside of a predetermined embedding space region, wherein the predetermined embedding space region is defined as a non-anomalous embedding space region; determine a navigational action for the host vehicle based on a determination that the representation in embedding space of the at least a portion of the captured image falls outside of the predetermined embedding space region; and cause at least one system associated with the host vehicle to implement the navigational action.

A method for navigating a host vehicle relative to a road segment includes: receiving a captured image acquired by a camera onboard the host vehicle; generating a representation in embedding space of at least a portion of the captured image; determining whether the representation in embedding space of the at least a portion of the captured image falls outside of a predetermined embedding space region, wherein the predetermined embedding space region is defined as a non-anomalous embedding space region; determining a navigational action for the host vehicle based on a determination that the representation in embedding space of the at least a portion of the captured image falls outside of the predetermined embedding space region; and causing at least one system associated with the host vehicle to implement the navigational action.

Consistent with other disclosed embodiments, non-transitory computer-readable storage media may store program instructions, which are executable by at least one processing device and perform any of the steps and/or methods described herein.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary system consistent with the disclosed embodiments.

FIG. 2A is a diagrammatic side view representation of an exemplary vehicle including a system consistent with the disclosed embodiments.

FIG. 2B is a diagrammatic top view representation of the vehicle and system shown in FIG. 2A consistent with the disclosed embodiments.

FIG. 2C is a diagrammatic top view representation of another embodiment of a vehicle including a system consistent with the disclosed embodiments.

FIG. 2D is a diagrammatic top view representation of yet another embodiment of a vehicle including a system consistent with the disclosed embodiments.

FIG. 2E is a diagrammatic top view representation of yet another embodiment of a vehicle including a system consistent with the disclosed embodiments.

FIG. 2F is a diagrammatic representation of exemplary vehicle control systems consistent with the disclosed embodiments.

FIG. 3A is a diagrammatic representation of an interior of a vehicle including a rearview mirror and a user interface for a vehicle imaging system consistent with the disclosed embodiments.

FIG. 3B is an illustration of an example of a camera mount that is configured to be positioned behind a rearview mirror and against a vehicle windshield consistent with the disclosed embodiments.

FIG. 3C is an illustration of the camera mount shown in FIG. 3B from a different perspective consistent with the disclosed embodiments.

FIG. 3D is an illustration of an example of a camera mount that is configured to be positioned behind a rearview mirror and against a vehicle windshield consistent with the disclosed embodiments.

FIG. 4 is an exemplary block diagram of a memory configured to store instructions for performing one or more operations consistent with the disclosed embodiments.

FIG. 5A is a flowchart showing an exemplary process for causing one or more navigational responses based on monocular image analysis consistent with disclosed embodiments.

FIG. 5B is a flowchart showing an exemplary process for detecting one or more vehicles and/or pedestrians in a set of images consistent with the disclosed embodiments.

FIG. 5C is a flowchart showing an exemplary process for detecting road marks and/or lane geometry information in a set of images consistent with the disclosed embodiments.

FIG. 5D is a flowchart showing an exemplary process for detecting traffic lights in a set of images consistent with the disclosed embodiments.

FIG. 5E is a flowchart showing an exemplary process for causing one or more navigational responses based on a vehicle path consistent with the disclosed embodiments.

FIG. 5F is a flowchart showing an exemplary process for determining whether a leading vehicle is changing lanes consistent with the disclosed embodiments.

FIG. 6 is a flowchart showing an exemplary process for causing one or more navigational responses based on stereo image analysis consistent with the disclosed embodiments.

FIG. 7 is a flowchart showing an exemplary process for causing one or more navigational responses based on an analysis of three sets of images consistent with the disclosed embodiments.

FIG. 8 provides a diagrammatic representation of a trained model, consistent with the disclosed embodiments.

FIG. 9 provides a diagrammatic representation of a trained model, consistent with the disclosed embodiments.

FIG. 10 provides a diagrammatic representation of a trained model, consistent with the disclosed embodiments.

FIG. 11 provides a representation of an anomalous scenario, consistent with the disclosed embodiments.

FIG. 12 provides a representation of an anomalous scenario, consistent with the disclosed embodiments.

FIG. 13 provides a representation of an anomalous scenario, consistent with the disclosed embodiments.

FIG. 14 provides a representation of an anomalous scenario, consistent with the disclosed embodiments.

FIG. 15 is a flowchart showing an exemplary method for navigating a host vehicle, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Autonomous Vehicle (AV) Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operational without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights, all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may usc information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations. The following sections provide an overview of a system consistent with the disclosed embodiments, followed by an overview of a forward-facing imaging system and methods consistent with the system. The sections that follow disclose systems and methods for constructing, using, and updating a sparse map for autonomous vehicle navigation.

### System Overview

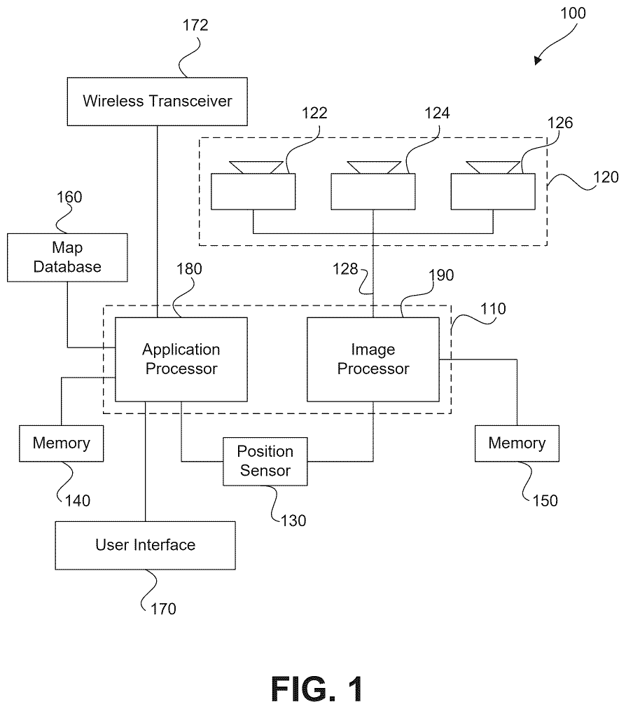

FIG. 1 is a block diagram representation of a system 100 consistent with the exemplary disclosed embodiments. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172. Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing unit 110 to image acquisition unit 120. For example, data interface 128 may include any wired and/or wireless link or links for transmitting image data acquired by image accusation unit 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.).

In some embodiments, applications processor 180 and/or image processor 190 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190.

In some embodiments, system 100 may include components such as a speed sensor (e.g., a tachometer, a speedometer) for measuring a speed of vehicle 200 and/or an accelerometer (either single axis or multi-axis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

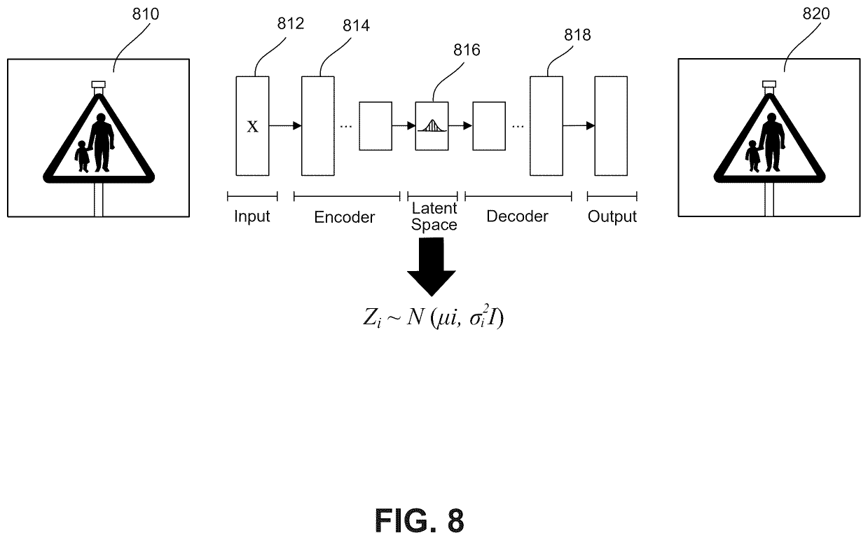

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle. Systems and methods of generating such a map are discussed below with references to FIGS. 8-19.

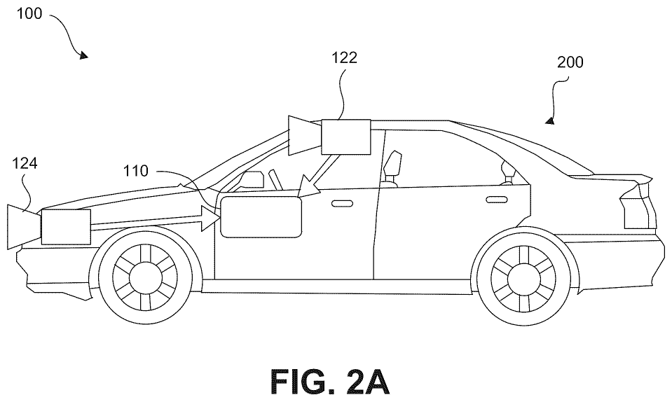

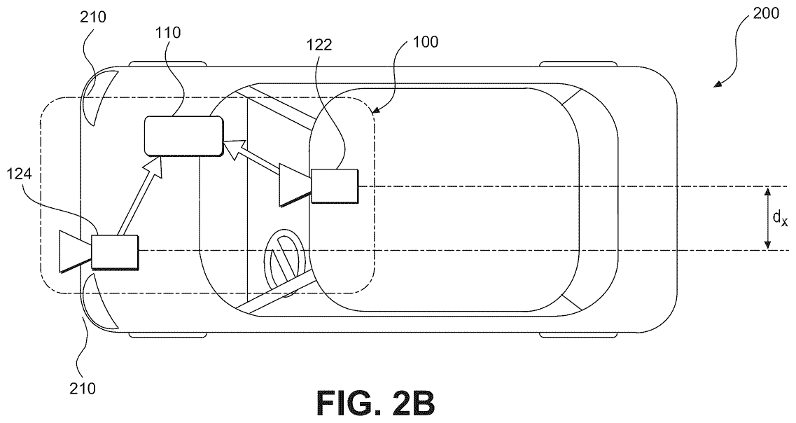

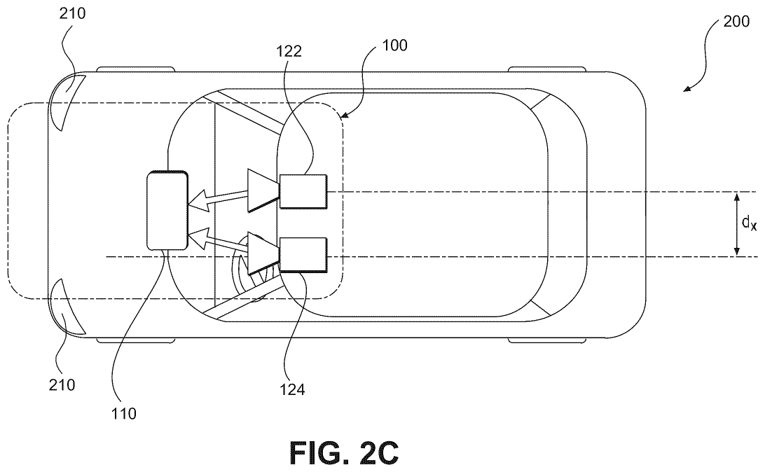

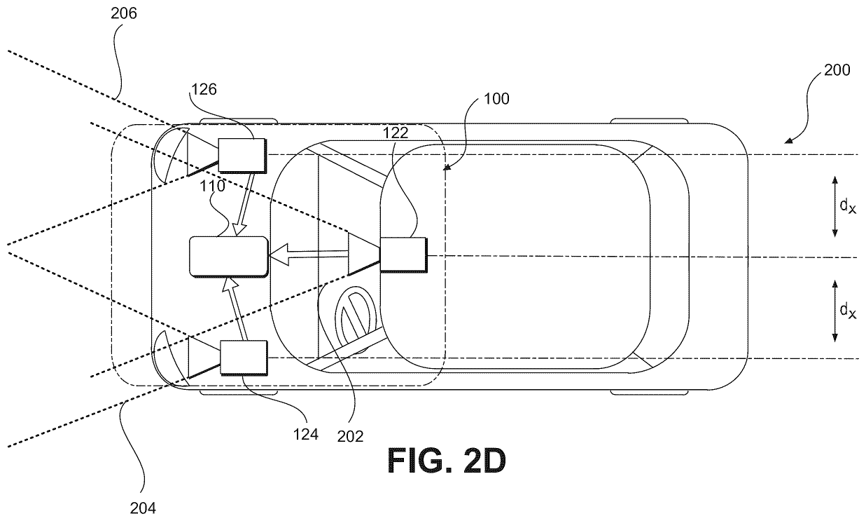

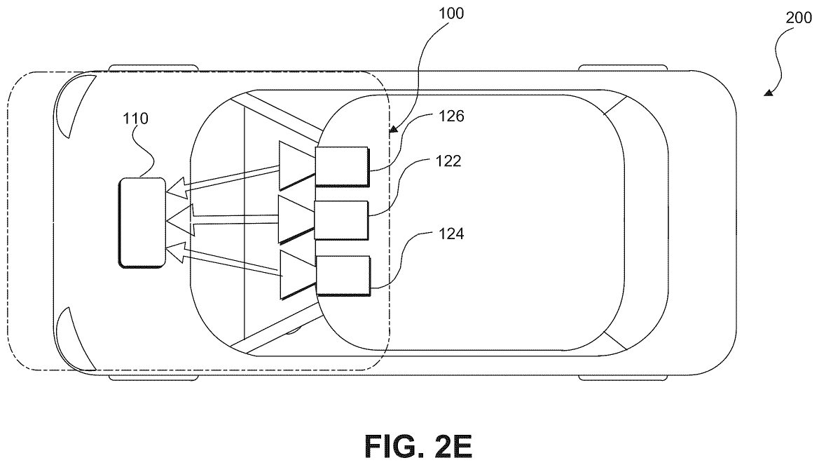

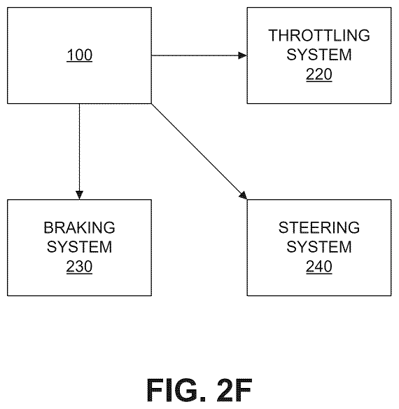

Image capture devices 122, 124, and 126 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 122, 124, and 126 will be further described with reference to FIGS. 2B-2E, below.

System 100, or various components thereof, may be incorporated into various different platforms. In some embodiments, system 100 may be included on a vehicle 200, as shown in FIG. 2A. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, such as those discussed in connection with FIGS. 2B-2E, multiple image capture devices may be used. For example, either of image capture devices 122 and 124 of vehicle 200, as shown in FIG. 2A, may be part of an ADAS (Advanced Driver Assistance Systems) imaging set.

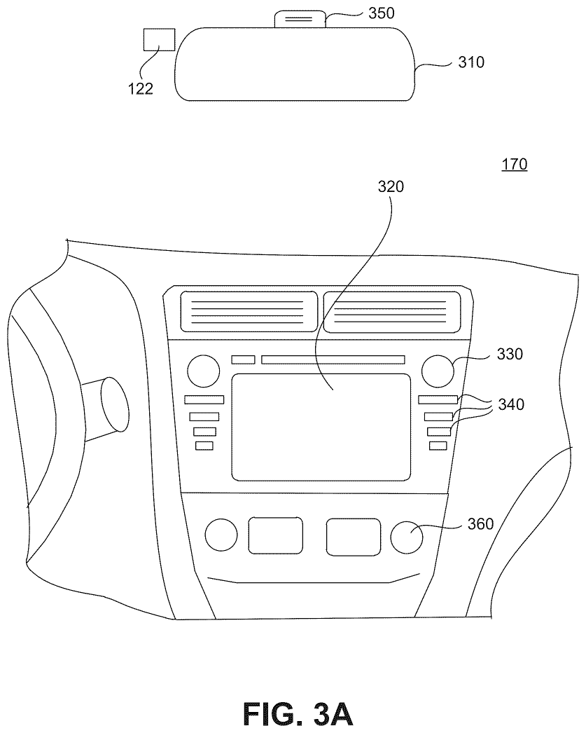

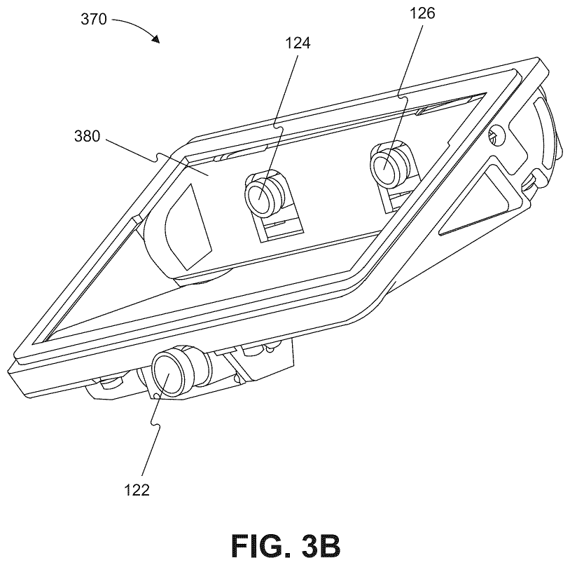

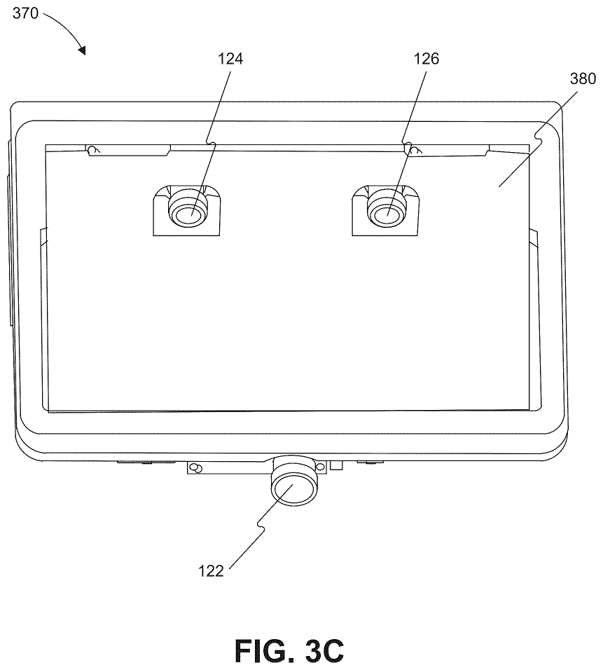

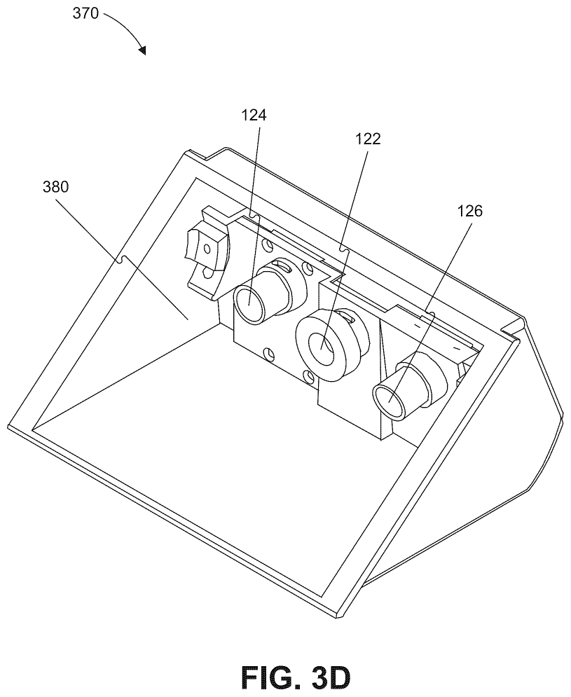

The image capture devices included on vehicle 200 as part of the image acquisition unit 120 may be positioned at any suitable location. In some embodiments, as shown in FIGS. 2A-2E and 3A-3C, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight.

Other locations for the image capture devices of image acquisition unit 120 may also be used. For example, image capture device 124 may be located on or in a bumper of vehicle 200. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 122, 124, and 126) may also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc.

In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

As discussed earlier, wireless transceiver 172 may and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers.

System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

In some embodiments, system 100 may upload data according to a “high” privacy level, and under setting a setting, system 100 may transmit data (e.g., location information related to a route, captured images, etc.) without any details about the specific vehicle and/or driver/owner. For example, when uploading data according to a “high” privacy setting, system 100 may not include a vehicle identification number (VIN) or a name of a driver or owner of the vehicle, and may instead of transmit data, such as captured images and/or limited location information related to a route.

Other privacy levels are contemplated. For example, system 100 may transmit data to a server according to an “intermediate” privacy level and include additional information not included under a “high” privacy level, such as a make and/or model of a vehicle and/or a vehicle type (e.g., a passenger vehicle, sport utility vehicle, truck, etc.). In some embodiments, system 100 may upload data according to a “low” privacy level. Under a “low” privacy level setting, system 100 may upload data and include information sufficient to uniquely identify a specific vehicle, owner/driver, and/or a portion or entirely of a route traveled by the vehicle. Such “low” privacy level data may include one or more of, for example, a VIN, a driver/owner name, an origination point of a vehicle prior to departure, an intended destination of the vehicle, a make and/or model of the vehicle, a type of the vehicle, etc.

FIG. 2A is a diagrammatic side view representation of an exemplary vehicle imaging system consistent with the disclosed embodiments. FIG. 2B is a diagrammatic top view illustration of the embodiment shown in FIG. 2A. As illustrated in FIG. 2B, the disclosed embodiments may include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror and/or near the driver of vehicle 200. Additionally, while two image capture devices 122 and 124 are shown in FIGS. 2B and 2C, it should be understood that other embodiments may include more than two image capture devices. For example, in the embodiments shown in FIGS. 2D and 2E, first, second, and third image capture devices 122, 124, and 126, are included in the system 100 of vehicle 200.

As illustrated in FIG. 2D, image capture device 122 may be positioned in the vicinity of the rearview mirror and/or near the driver of vehicle 200, and image capture devices 124 and 126 may be positioned on or in a bumper region (e.g., one of bumper regions 210) of vehicle 200. And as shown in FIG. 2E, image capture devices 122, 124, and 126 may be positioned in the vicinity of the rearview mirror and/or near the driver seat of vehicle 200. The disclosed embodiments are not limited to any particular number and configuration of the image capture devices, and the image capture devices may be positioned in any appropriate location within and/or on vehicle 200.

It is to be understood that the disclosed embodiments are not limited to vehicles and could be applied in other contexts. It is also to be understood that disclosed embodiments are not limited to a particular type of vehicle 200 and may be applicable to all types of vehicles including automobiles, trucks, trailers, and other types of vehicles.

The first image capture device 122 may include any suitable type of image capture device. Image capture device 122 may include an optical axis. In one instance, the image capture device 122 may include an Aptina M9V024 WVGA sensor with a global shutter. In other embodiments, image capture device 122 may provide a resolution of 1280×960 pixels and may include a rolling shutter. Image capture device 122 may include various optical elements. In some embodiments one or more lenses may be included, for example, to provide a desired focal length and field of view for the image capture device. In some embodiments, image capture device 122 may be associated with a 6 mm lens or a 12 mm lens. In some embodiments, image capture device 122 may be configured to capture images having a desired field-of-view (FOV) 202, as illustrated in FIG. 2D. For example, image capture device 122 may be configured to have a regular FOV, such as within a range of 40 degrees to 56 degrees, including a 46 degree FOV, 50 degree FOV, 52 degree FOV, or greater. Alternatively, image capture device 122 may be configured to have a narrow FOV in the range of 23 to 40 degrees, such as a 28 degree FOV or 36 degree FOV. In addition, image capture device 122 may be configured to have a wide FOV in the range of 100 to 180 degrees. In some embodiments, image capture device 122 may include a wide angle bumper camera or one with up to a 180 degree FOV. In some embodiments, image capture device 122 may be a 7.2M pixel image capture device with an aspect ratio of about 2:1 (e.g., H×V=3800×1900 pixels) with about 100 degree horizontal FOV. Such an image capture device may be used in place of a three image capture device configuration. Due to significant lens distortion, the vertical FOV of such an image capture device may be significantly less than 50 degrees in implementations in which the image capture device uses a radially symmetric lens. For example, such a lens may not be radially symmetric which would allow for a vertical FOV greater than 50 degrees with 100 degree horizontal FOV.

The first image capture device 122 may acquire a plurality of first images relative to a scene associated with the vehicle 200. Each of the plurality of first images may be acquired as a series of image scan lines, which may be captured using a rolling shutter. Each scan line may include a plurality of pixels.

The first image capture device 122 may have a scan rate associated with acquisition of each of the first series of image scan lines. The scan rate may refer to a rate at which an image sensor can acquire image data associated with each pixel included in a particular scan line.

Image capture devices 122, 124, and 126 may contain any suitable type and number of image sensors, including CCD sensors or CMOS sensors, for example. In one embodiment, a CMOS image sensor may be employed along with a rolling shutter, such that each pixel in a row is read one at a time, and scanning of the rows proceeds on a row-by-row basis until an entire image frame has been captured. In some embodiments, the rows may be captured sequentially from top to bottom relative to the frame.

In some embodiments, one or more of the image capture devices (e.g., image capture devices 122, 124, and 126) disclosed herein may constitute a high resolution imager and may have a resolution greater than 5M pixel, 7M pixel, 10M pixel, or greater.

The use of a rolling shutter may result in pixels in different rows being exposed and captured at different times, which may cause skew and other image artifacts in the captured image frame. On the other hand, when the image capture device 122 is configured to operate with a global or synchronous shutter, all of the pixels may be exposed for the same amount of time and during a common exposure period. As a result, the image data in a frame collected from a system employing a global shutter represents a snapshot of the entire FOV (such as FOV 202) at a particular time. In contrast, in a rolling shutter application, each row in a frame is exposed and data is capture at different times. Thus, moving objects may appear distorted in an image capture device having a rolling shutter. This phenomenon will be described in greater detail below.

The second image capture device 124 and the third image capturing device 126 may be any type of image capture device. Like the first image capture device 122, each of image capture devices 124 and 126 may include an optical axis. In one embodiment, each of image capture devices 124 and 126 may include an Aptina M9V024 WVGA sensor with a global shutter. Alternatively, each of image capture devices 124 and 126 may include a rolling shutter. Like image capture device 122, image capture devices 124 and 126 may be configured to include various lenses and optical elements. In some embodiments, lenses associated with image capture devices 124 and 126 may provide FOVs (such as FOVs 204 and 206) that are the same as, or narrower than, a FOV (such as FOV 202) associated with image capture device 122. For example, image capture devices 124 and 126 may have FOVs of 40 degrees, 30 degrees, 26 degrees, 23 degrees, 20 degrees, or less.

Image capture devices 124 and 126 may acquire a plurality of second and third images relative to a scene associated with the vehicle 200. Each of the plurality of second and third images may be acquired as a second and third series of image scan lines, which may be captured using a rolling shutter. Each scan line or row may have a plurality of pixels. Image capture devices 124 and 126 may have second and third scan rates associated with acquisition of each of image scan lines included in the second and third series.

Each image capture device 122, 124, and 126 may be positioned at any suitable position and orientation relative to vehicle 200. The relative positioning of the image capture devices 122, 124, and 126 may be selected to aid in fusing together the information acquired from the image capture devices. For example, in some embodiments, a FOV (such as FOV 204) associated with image capture device 124 may overlap partially or fully with a FOV (such as FOV 202) associated with image capture device 122 and a FOV (such as FOV 206) associated with image capture device 126.

Image capture devices 122, 124, and 126 may be located on vehicle 200 at any suitable relative heights. In one instance, there may be a height difference between the image capture devices 122, 124, and 126, which may provide sufficient parallax information to enable stereo analysis. For example, as shown in FIG. 2A, the two image capture devices 122 and 124 are at different heights. There may also be a lateral displacement difference between image capture devices 122, 124, and 126, giving additional parallax information for stereo analysis by processing unit 110, for example. The difference in the lateral displacement may be denoted by dx, as shown in FIGS. 2C and 2D. In some embodiments, fore or aft displacement (e.g., range displacement) may exist between image capture devices 122, 124, and 126. For example, image capture device 122 may be located 0.5 to 2 meters or more behind image capture device 124 and/or image capture device 126. This type of displacement may enable one of the image capture devices to cover potential blind spots of the other image capture device(s).

Image capture devices 122 may have any suitable resolution capability (e.g., number of pixels associated with the image sensor), and the resolution of the image sensor(s) associated with the image capture device 122 may be higher, lower, or the same as the resolution of the image sensor(s) associated with image capture devices 124 and 126. In some embodiments, the image sensor(s) associated with image capture device 122 and/or image capture devices 124 and 126 may have a resolution of 640×480, 1024×768, 1280×960, or any other suitable resolution.

The frame rate (e.g., the rate at which an image capture device acquires a set of pixel data of one image frame before moving on to capture pixel data associated with the next image frame) may be controllable. The frame rate associated with image capture device 122 may be higher, lower, or the same as the frame rate associated with image capture devices 124 and 126. The frame rate associated with image capture devices 122, 124, and 126 may depend on a variety of factors that may affect the timing of the frame rate. For example, one or more of image capture devices 122, 124, and 126 may include a selectable pixel delay period imposed before or after acquisition of image data associated with one or more pixels of an image sensor in image capture device 122, 124, and/or 126. Generally, image data corresponding to each pixel may be acquired according to a clock rate for the device (e.g., one pixel per clock cycle). Additionally, in embodiments including a rolling shutter, one or more of image capture devices 122, 124, and 126 may include a selectable horizontal blanking period imposed before or after acquisition of image data associated with a row of pixels of an image sensor in image capture device 122, 124, and/or 126. Further, one or more of image capture devices 122, 124, and/or 126 may include a selectable vertical blanking period imposed before or after acquisition of image data associated with an image frame of image capture device 122, 124, and 126.

These timing controls may enable synchronization of frame rates associated with image capture devices 122, 124, and 126, even where the line scan rates of each are different. Additionally, as will be discussed in greater detail below, these selectable timing controls, among other factors (e.g., image sensor resolution, maximum line scan rates, etc.) may enable synchronization of image capture from an area where the FOV of image capture device 122 overlaps with one or more FOVs of image capture devices 124 and 126, even where the field of view of image capture device 122 is different from the FOVs of image capture devices 124 and 126.

Frame rate timing in image capture device 122, 124, and 126 may depend on the resolution of the associated image sensors. For example, assuming similar line scan rates for both devices, if one device includes an image sensor having a resolution of 640×480 and another device includes an image sensor with a resolution of 1280×960, then more time will be required to acquire a frame of image data from the sensor having the higher resolution.

Another factor that may affect the timing of image data acquisition in image capture devices 122, 124, and 126 is the maximum line scan rate. For example, acquisition of a row of image data from an image sensor included in image capture device 122, 124, and 126 will require some minimum amount of time. Assuming no pixel delay periods are added, this minimum amount of time for acquisition of a row of image data will be related to the maximum line scan rate for a particular device. Devices that offer higher maximum line scan rates have the potential to provide higher frame rates than devices with lower maximum line scan rates. In some embodiments, one or more of image capture devices 124 and 126 may have a maximum line scan rate that is higher than a maximum line scan rate associated with image capture device 122. In some embodiments, the maximum line scan rate of image capture device 124 and/or 126 may be 1.25, 1.5, 1.75, or 2 times or more than a maximum line scan rate of image capture device 122.

In another embodiment, image capture devices 122, 124, and 126 may have the same maximum line scan rate, but image capture device 122 may be operated at a scan rate less than or equal to its maximum scan rate. The system may be configured such that one or more of image capture devices 124 and 126 operate at a line scan rate that is equal to the line scan rate of image capture device 122. In other instances, the system may be configured such that the line scan rate of image capture device 124 and/or image capture device 126 may be 1.25, 1.5, 1.75, or 2 times or more than the line scan rate of image capture device 122.

In some embodiments, image capture devices 122, 124, and 126 may be asymmetric. That is, they may include cameras having different fields of view (FOV) and focal lengths. The fields of view of image capture devices 122, 124, and 126 may include any desired area relative to an environment of vehicle 200, for example. In some embodiments, one or more of image capture devices 122, 124, and 126 may be configured to acquire image data from an environment in front of vehicle 200, behind vehicle 200, to the sides of vehicle 200, or combinations thereof.

Further, the focal length associated with each image capture device 122, 124, and/or 126 may be selectable (e.g., by inclusion of appropriate lenses etc.) such that each device acquires images of objects at a desired distance range relative to vehicle 200. For example, in some embodiments image capture devices 122, 124, and 126 may acquire images of close-up objects within a few meters from the vehicle. Image capture devices 122, 124, and 126 may also be configured to acquire images of objects at ranges more distant from the vehicle (e.g., 25 m, 50 m, 100 m, 150 m, or more). Further, the focal lengths of image capture devices 122, 124, and 126 may be selected such that one image capture device (e.g., image capture device 122) can acquire images of objects relatively close to the vehicle (e.g., within 10 m or within 20 m) while the other image capture devices (e.g., image capture devices 124 and 126) can acquire images of more distant objects (e.g., greater than 20 m, 50 m, 100 m, 150 m, etc.) from vehicle 200.

According to some embodiments, the FOV of one or more image capture devices 122, 124, and 126 may have a wide angle. For example, it may be advantageous to have a FOV of 140 degrees, especially for image capture devices 122, 124, and 126 that may be used to capture images of the area in the vicinity of vehicle 200. For example, image capture device 122 may be used to capture images of the area to the right or left of vehicle 200 and, in such embodiments, it may be desirable for image capture device 122 to have a wide FOV (e.g., at least 140 degrees).

The field of view associated with each of image capture devices 122, 124, and 126 may depend on the respective focal lengths. For example, as the focal length increases, the corresponding field of view decreases.

Image capture devices 122, 124, and 126 may be configured to have any suitable fields of view. In one particular example, image capture device 122 may have a horizontal FOV of 46 degrees, image capture device 124 may have a horizontal FOV of 23 degrees, and image capture device 126 may have a horizontal FOV in between 23 and 46 degrees. In another instance, image capture device 122 may have a horizontal FOV of 52 degrees, image capture device 124 may have a horizontal FOV of 26 degrees, and image capture device 126 may have a horizontal FOV in between 26 and 52 degrees. In some embodiments, a ratio of the FOV of image capture device 122 to the FOVs of image capture device 124 and/or image capture device 126 may vary from 1.5 to 2.0. In other embodiments, this ratio may vary between 1.25 and 2.25.

System 100 may be configured so that a field of view of image capture device 122 overlaps, at least partially or fully, with a field of view of image capture device 124 and/or image capture device 126. In some embodiments, system 100 may be configured such that the fields of view of image capture devices 124 and 126, for example, fall within (e.g., are narrower than) and share a common center with the field of view of image capture device 122. In other embodiments, the image capture devices 122, 124, and 126 may capture adjacent FOVs or may have partial overlap in their FOVs. In some embodiments, the fields of view of image capture devices 122, 124, and 126 may be aligned such that a center of the narrower FOV image capture devices 124 and/or 126 may be located in a lower half of the field of view of the wider FOV image capture device 122.

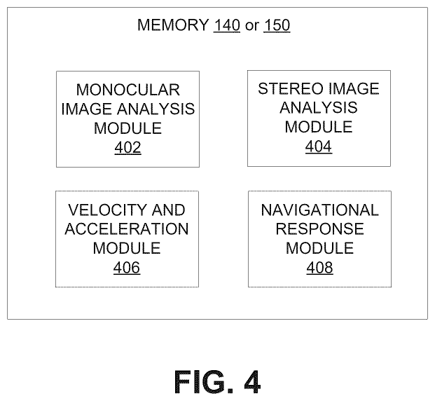

FIG. 2F is a diagrammatic representation of exemplary vehicle control systems, consistent with the disclosed embodiments. As indicated in FIG. 2F, vehicle 200 may include throttling system 220, braking system 230, and steering system 240. System 100 may provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 may provide control signals to one or more of throttling system 220, braking system 230, and steering system 240 to navigate vehicle 200 (e.g., by causing an acceleration, a turn, a lane shift, etc.). Further, system 100 may receive inputs from one or more of throttling system 220, braking system 230, and steering system 24 indicating operating conditions of vehicle 200 (e.g., speed, whether vehicle 200 is braking and/or turning, etc.). Further details are provided in connection with FIGS. 4-7, below.

As shown in FIG. 3A, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

FIGS. 3B-3D are illustrations of an exemplary camera mount 370 configured to be positioned behind a rearview mirror (e.g., rearview mirror 310) and against a vehicle windshield, consistent with disclosed embodiments. As shown in FIG. 3B, camera mount 370 may include image capture devices 122, 124, and 126. Image capture devices 124 and 126 may be positioned behind a glare shield 380, which may be flush against the vehicle windshield and include a composition of film and/or anti-reflective materials. For example, glare shield 380 may be positioned such that the shield aligns against a vehicle windshield having a matching slope. In some embodiments, each of image capture devices 122, 124, and 126 may be positioned behind glare shield 380, as depicted, for example, in FIG. 3D. The disclosed embodiments are not limited to any particular configuration of image capture devices 122, 124, and 126, camera mount 370, and glare shield 380. FIG. 3C is an illustration of camera mount 370 shown in FIG. 3B from a front perspective.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 in response to the analysis.

As discussed below in further detail and consistent with various disclosed embodiments, system 100 may provide a variety of features related to autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings and/or alerts to vehicle occupants based on the analysis of the collected data. Additional details regarding the various embodiments that are provided by system 100 are provided below.

### Forward-Facing Multi-Imaging System

As discussed above, system 100 may provide drive assist functionality that uses a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three camera configuration using image capture devices 122, 124, and 126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122, 124, and 126 may be positioned behind rearview mirror 310 and positioned substantially side-by-side (e.g., 6 cm apart). Further, in some embodiments, as discussed above, one or more of image capture devices 122, 124, and 126 may be mounted behind glare shield 380 that is flush with the windshield of vehicle 200. Such shielding may act to minimize the impact of any reflections from inside the car on image capture devices 122, 124, and 126.

In another embodiment, as discussed above in connection with FIGS. 3B and 3C, the wide field of view camera (e.g., image capture device 124 in the above example) may be mounted lower than the narrow and main field of view cameras (e.g., image capture devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three camera system may provide certain performance characteristics. For example, some embodiments may include an ability to validate the detection of objects by one camera based on detection results from another camera. In the three camera configuration discussed above, processing unit 110 may include, for example, three processing devices (e.g., three EyeQ series of processor chips, as discussed above), with each processing device dedicated to processing images captured by one or more of image capture devices 122, 124, and 126.

In a three camera system, a first processing device may receive images from both the main camera and the narrow field of view camera, and perform vision processing of the narrow FOV camera to, for example, detect other vehicles, pedestrians, lane marks, traffic signs, traffic lights, and other road objects. Further, the first processing device may calculate a disparity of pixels between the images from the main camera and the narrow camera and create a 3D reconstruction of the environment of vehicle 200. The first processing device may then combine the 3D reconstruction with 3D map data or with 3D information calculated based on information from another camera.

The second processing device may receive images from main camera and perform vision processing to detect other vehicles, pedestrians, lane marks, traffic signs, traffic lights, and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion based 3D reconstruction to the first processing device to be combined with the stereo 3D images.

The third processing device may receive images from the wide FOV camera and process the images to detect vehicles, pedestrians, lane marks, traffic signs, traffic lights, and other road objects. The third processing device may further execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system). Furthermore, in some embodiments, redundancy and validation of received data may be supplemented based on information received from one more sensors (e.g., radar, lidar, acoustic sensors, information received from one or more transceivers outside of a vehicle, etc.).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

FIG. 4 is an exemplary functional block diagram of memory 140 and/or 150, which may be stored/programmed with instructions for performing one or more operations consistent with the disclosed embodiments. Although the following refers to memory 140, one of skill in the art will recognize that instructions may be stored in memory 140 and/or 150.

As shown in FIG. 4, memory 140 may store a monocular image analysis module 402, a stereo image analysis module 404, a velocity and acceleration module 406, and a navigational response module 408. The disclosed embodiments are not limited to any particular configuration of memory 140. Further, application processor 180 and/or image processor 190 may execute the instructions stored in any of modules 402, 404, 406, and 408 included in memory 140. One of skill in the art will understand that references in the following discussions to processing unit 110 may refer to application processor 180 and image processor 190 individually or collectively. Accordingly, steps of any of the following processes may be performed by one or more processing devices.

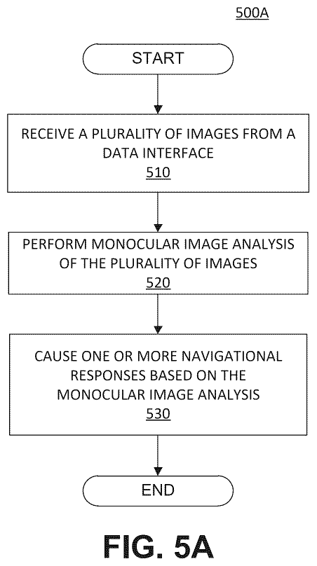

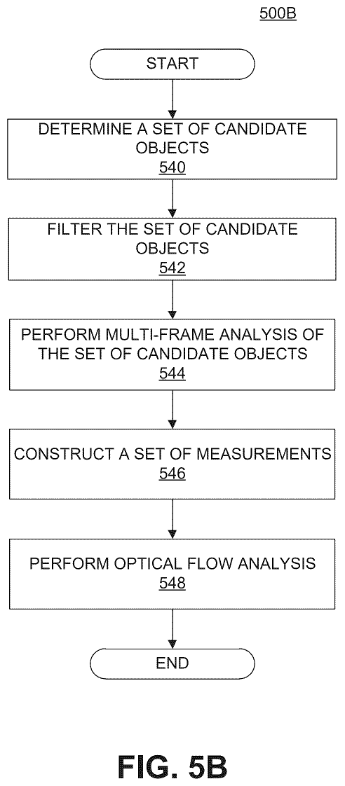

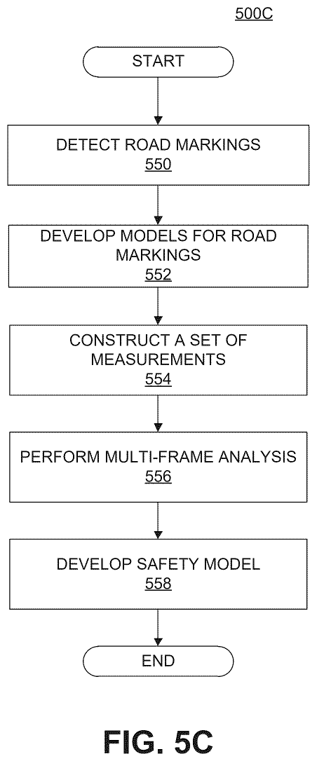

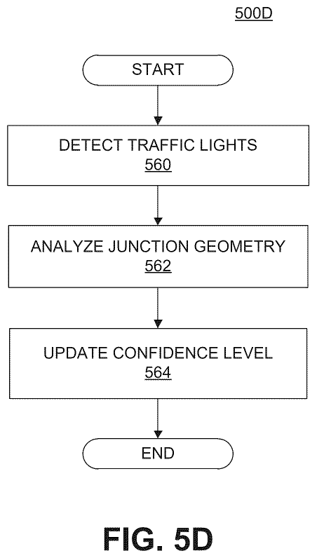

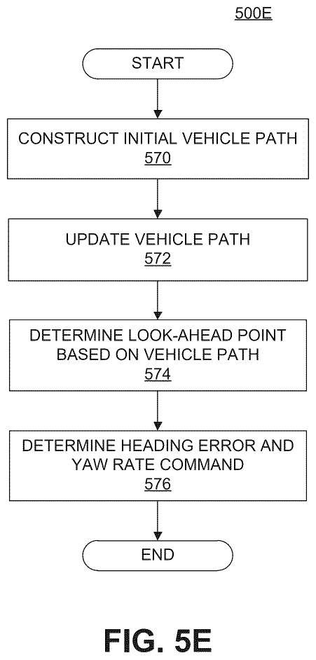

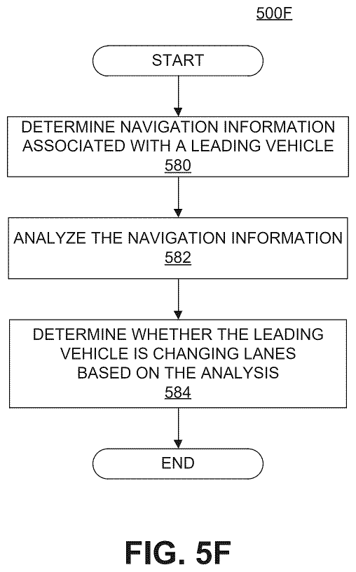

In one embodiment, monocular image analysis module 402 may store instructions (such as computer vision software) which, when executed by processing unit 110, performs monocular image analysis of a set of images acquired by one of image capture devices 122, 124, and 126. In some embodiments, processing unit 110 may combine information from a set of images with additional sensory information (e.g., information from radar, lidar, etc.) to perform the monocular image analysis. As described in connection with FIGS. 5A-5D below, monocular image analysis module 402 may include instructions for detecting a set of features within the set of images, such as lane markings, vehicles, pedestrians, road signs, highway exit ramps, traffic lights, hazardous objects, and any other feature associated with an environment of a vehicle. Based on the analysis, system 100 (e.g., via processing unit 110) may cause one or more navigational responses in vehicle 200, such as a turn, a lane shift, a change in acceleration, and the like, as discussed below in connection with navigational response module 408.

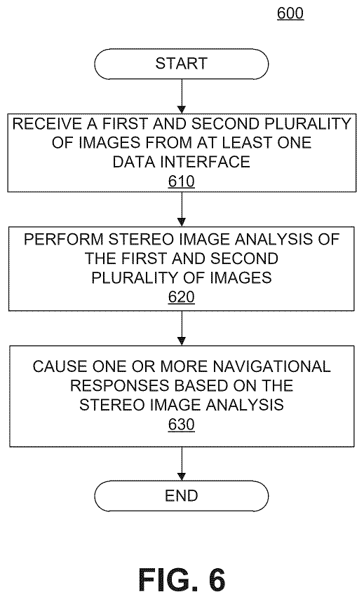

In one embodiment, stereo image analysis module 404 may store instructions (such as computer vision software) which, when executed by processing unit 110, performs stereo image analysis of first and second sets of images acquired by a combination of image capture devices selected from any of image capture devices 122, 124, and 126. In some embodiments, processing unit 110 may combine information from the first and second sets of images with additional sensory information (e.g., information from radar) to perform the stereo image analysis. For example, stereo image analysis module 404 may include instructions for performing stereo image analysis based on a first set of images acquired by image capture device 124 and a second set of images acquired by image capture device 126. As described in connection with FIG. 6 below, stereo image analysis module 404 may include instructions for detecting a set of features within the first and second sets of images, such as lane markings, vehicles, pedestrians, road signs, highway exit ramps, traffic lights, hazardous objects, and the like. Based on the analysis, processing unit 110 may cause one or more navigational responses in vehicle 200, such as a turn, a lane shift, a change in acceleration, and the like, as discussed below in connection with navigational response module 408. Furthermore, in some embodiments, stereo image analysis module 404 may implement techniques associated with a trained system (such as a neural network or a deep neural network) or an untrained system, such as a system that may be configured to use computer vision algorithms to detect and/or label objects in an environment from which sensory information was captured and processed. In one embodiment, stereo image analysis module 404 and/or other image processing modules may be configured to use a combination of a trained and untrained system.

In one embodiment, velocity and acceleration module 406 may store software configured to analyze data received from one or more computing and electromechanical devices in vehicle 200 that are configured to cause a change in velocity and/or acceleration of vehicle 200. For example, processing unit 110 may execute instructions associated with velocity and acceleration module 406 to calculate a target speed for vehicle 200 based on data derived from execution of monocular image analysis module 402 and/or stereo image analysis module 404. Such data may include, for example, a target position, velocity, and/or acceleration, the position and/or speed of vehicle 200 relative to a nearby vehicle, pedestrian, or road object, position information for vehicle 200 relative to lane markings of the road, and the like. In addition, processing unit 110 may calculate a target speed for vehicle 200 based on sensory input (e.g., information from radar) and input from other systems of vehicle 200, such as throttling system 220, braking system 230, and/or steering system 240 of vehicle 200. Based on the calculated target speed, processing unit 110 may transmit electronic signals to throttling system 220, braking system 230, and/or steering system 240 of vehicle 200 to trigger a change in velocity and/or acceleration by, for example, physically depressing the brake or casing up off the accelerator of vehicle 200.

In one embodiment, navigational response module 408 may store software executable by processing unit 110 to determine a desired navigational response based on data derived from execution of monocular image analysis module 402 and/or stereo image analysis module 404. Such data may include position and speed information associated with nearby vehicles, pedestrians, and road objects, target position information for vehicle 200, and the like. Additionally, in some embodiments, the navigational response may be based (partially or fully) on map data, a predetermined position of vehicle 200, and/or a relative velocity or a relative acceleration between vehicle 200 and one or more objects detected from execution of monocular image analysis module 402 and/or stereo image analysis module 404. Navigational response module 408 may also determine a desired navigational response based on sensory input (e.g., information from radar) and inputs from other systems of vehicle 200, such as throttling system 220, braking system 230, and steering system 240 of vehicle 200. Based on the desired navigational response, processing unit 110 may transmit electronic signals to throttling system 220, braking system 230, and steering system 240 of vehicle 200 to trigger a desired navigational response by, for example, turning the steering wheel of vehicle 200 to achieve a rotation of a predetermined angle. In some embodiments, processing unit 110 may use the output of navigational response module 408 (e.g., the desired navigational response) as an input to execution of velocity and acceleration module 406 for calculating a change in speed of vehicle 200.

Furthermore, any of the modules (e.g., modules 402, 404, and 406) disclosed herein may implement techniques associated with a trained system (such as a neural network or a deep neural network) or an untrained system.

FIG. 5A is a flowchart showing an exemplary process 500A for causing one or more navigational responses based on monocular image analysis, consistent with disclosed embodiments. At step 510, processing unit 110 may receive a plurality of images via data interface 128 between processing unit 110 and image acquisition unit 120. For instance, a camera included in image acquisition unit 120 (such as image capture device 122 having field of view 202) may capture a plurality of images of an area forward of vehicle 200 (or to the sides or rear of a vehicle, for example) and transmit them over a data connection (e.g., digital, wired, USB, wireless, Bluetooth, etc.) to processing unit 110. Processing unit 110 may execute monocular image analysis module 402 to analyze the plurality of images at step 520, as described in further detail in connection with FIGS. 5B-5D below. By performing the analysis, processing unit 110 may detect a set of features within the set of images, such as lane markings, vehicles, pedestrians, road signs, highway exit ramps, traffic lights, and the like.

Processing unit 110 may also execute monocular image analysis module 402 to detect various road hazards at step 520, such as, for example, parts of a truck tire, fallen road signs, loose cargo, small animals, and the like. Road hazards may vary in structure, shape, size, and color, which may make detection of such hazards more challenging. In some embodiments, processing unit 110 may execute monocular image analysis module 402 to perform multi-frame analysis on the plurality of images to detect road hazards. For example, processing unit 110 may estimate camera motion between consecutive image frames and calculate the disparities in pixels between the frames to construct a 3D-map of the road. Processing unit 110 may then use the 3D-map to detect the road surface, as well as hazards existing above the road surface.

At step 530, processing unit 110 may execute navigational response module 408 to cause one or more navigational responses in vehicle 200 based on the analysis performed at step 520 and the techniques as described above in connection with FIG. 4. Navigational responses may include, for example, a turn, a lane shift, a change in acceleration, and the like. In some embodiments, processing unit 110 may use data derived from execution of velocity and acceleration module 406 to cause the one or more navigational responses. Additionally, multiple navigational responses may occur simultaneously, in sequence, or any combination thereof. For instance, processing unit 110 may cause vehicle 200 to shift one lane over and then accelerate by, for example, sequentially transmitting control signals to steering system 240 and throttling system 220 of vehicle 200. Alternatively, processing unit 110 may cause vehicle 200 to brake while at the same time shifting lanes by, for example, simultaneously transmitting control signals to braking system 230 and steering system 240 of vehicle 200.

FIG. 5B is a flowchart showing an exemplary process 500B for detecting one or more vehicles and/or pedestrians in a set of images, consistent with disclosed embodiments. Processing unit 110 may execute monocular image analysis module 402 to implement process 500B. At step 540, processing unit 110 may determine a set of candidate objects representing possible vehicles and/or pedestrians. For example, processing unit 110 may scan one or more images, compare the images to one or more predetermined patterns, and identify within each image possible locations that may contain objects of interest (e.g., vehicles, pedestrians, or portions thereof). The predetermined patterns may be designed in such a way to achieve a high rate of “false hits” and a low rate of “misses.” For example, processing unit 110 may use a low threshold of similarity to predetermined patterns for identifying candidate objects as possible vehicles or pedestrians. Doing so may allow processing unit 110 to reduce the probability of missing (e.g., not identifying) a candidate object representing a vehicle or pedestrian.

At step 542, processing unit 110 may filter the set of candidate objects to exclude certain candidates (e.g., irrelevant or less relevant objects) based on classification criteria. Such criteria may be derived from various properties associated with object types stored in a database (e.g., a database stored in memory 140). Properties may include object shape, dimensions, texture, position (e.g., relative to vehicle 200), and the like. Thus, processing unit 110 may use one or more sets of criteria to reject false candidates from the set of candidate objects.

At step 544, processing unit 110 may analyze multiple frames of images to determine whether objects in the set of candidate objects represent vehicles and/or pedestrians. For example, processing unit 110 may track a detected candidate object across consecutive frames and accumulate frame-by-frame data associated with the detected object (e.g., size, position relative to vehicle 200, etc.). Additionally, processing unit 110 may estimate parameters for the detected object and compare the object's frame-by-frame position data to a predicted position.

At step 546, processing unit 110 may construct a set of measurements for the detected objects. Such measurements may include, for example, position, velocity, and acceleration values (relative to vehicle 200) associated with the detected objects. In some embodiments, processing unit 110 may construct the measurements based on estimation techniques using a series of time-based observations such as Kalman filters or linear quadratic estimation (LQE), and/or based on available modeling data for different object types (e.g., cars, trucks, pedestrians, bicycles, road signs, etc.). The Kalman filters may be based on a measurement of an object's scale, where the scale measurement is proportional to a time to collision (e.g., the amount of time for vehicle 200 to reach the object). Thus, by performing steps 540-546, processing unit 110 may identify vehicles and pedestrians appearing within the set of captured images and derive information (e.g., position, speed, size) associated with the vehicles and pedestrians. Based on the identification and the derived information, processing unit 110 may cause one or more navigational responses in vehicle 200, as described in connection with FIG. 5A, above.

At step 548, processing unit 110 may perform an optical flow analysis of one or more images to reduce the probabilities of detecting a “false hit” and missing a candidate object that represents a vehicle or pedestrian. The optical flow analysis may refer to, for example, analyzing motion patterns relative to vehicle 200 in the one or more images associated with other vehicles and pedestrians, and that are distinct from road surface motion. Processing unit 110 may calculate the motion of candidate objects by observing the different positions of the objects across multiple image frames, which are captured at different times. Processing unit 110 may use the position and time values as inputs into mathematical models for calculating the motion of the candidate objects. Thus, optical flow analysis may provide another method of detecting vehicles and pedestrians that are nearby vehicle 200. Processing unit 110 may perform optical flow analysis in combination with steps 540-546 to provide redundancy for detecting vehicles and pedestrians and increase the reliability of system 100.

FIG. 5C is a flowchart showing an exemplary process 500C for detecting road marks and/or lane geometry information in a set of images, consistent with disclosed embodiments. Processing unit 110 may execute monocular image analysis module 402 to implement process 500C. At step 550, processing unit 110 may detect a set of objects by scanning one or more images. To detect segments of lane markings, lane geometry information, and other pertinent road marks, processing unit 110 may filter the set of objects to exclude those determined to be irrelevant (e.g., minor potholes, small rocks, etc.). At step 552, processing unit 110 may group together the segments detected in step 550 belonging to the same road mark or lane mark. Based on the grouping, processing unit 110 may develop a model to represent the detected segments, such as a mathematical model.

At step 554, processing unit 110 may construct a set of measurements associated with the detected segments. In some embodiments, processing unit 110 may create a projection of the detected segments from the image plane onto the real-world plane. The projection may be characterized using a 3rd-degree polynomial having coefficients corresponding to physical properties such as the position, slope, curvature, and curvature derivative of the detected road. In generating the projection, processing unit 110 may take into account changes in the road surface, as well as pitch and roll rates associated with vehicle 200. In addition, processing unit 110 may model the road elevation by analyzing position and motion cues present on the road surface. Further, processing unit 110 may estimate the pitch and roll rates associated with vehicle 200 by tracking a set of feature points in the one or more images.

At step 556, processing unit 110 may perform multi-frame analysis by, for example, tracking the detected segments across consecutive image frames and accumulating frame-by-frame data associated with detected segments. As processing unit 110 performs multi-frame analysis, the set of measurements constructed at step 554 may become more reliable and associated with an increasingly higher confidence level. Thus, by performing steps 550, 552, 554, and 556, processing unit 110 may identify road marks appearing within the set of captured images and derive lane geometry information. Based on the identification and the derived information, processing unit 110 may cause one or more navigational responses in vehicle 200, as described in connection with FIG. 5A, above.

At step 558, processing unit 110 may consider additional sources of information to further develop a safety model for vehicle 200 in the context of its surroundings. Processing unit 110 may use the safety model to define a context in which system 100 may execute autonomous control of vehicle 200 in a safe manner. To develop the safety model, in some embodiments, processing unit 110 may consider the position and motion of other vehicles, the detected road edges and barriers, and/or general road shape descriptions extracted from map data (such as data from map database 160). By considering additional sources of information, processing unit 110 may provide redundancy for detecting road marks and lane geometry and increase the reliability of system 100.

FIG. 5D is a flowchart showing an exemplary process 500D for detecting traffic lights in a set of images, consistent with disclosed embodiments. Processing unit 110 may execute monocular image analysis module 402 to implement process 500D. At step 560, processing unit 110 may scan the set of images and identify objects appearing at locations in the images likely to contain traffic lights. For example, processing unit 110 may filter the identified objects to construct a set of candidate objects, excluding those objects unlikely to correspond to traffic lights. The filtering may be done based on various properties associated with traffic lights, such as shape, dimensions, texture, position (e.g., relative to vehicle 200), and the like. Such properties may be based on multiple examples of traffic lights and traffic control signals and stored in a database. In some embodiments, processing unit 110 may perform multi-frame analysis on the set of candidate objects reflecting possible traffic lights. For example, processing unit 110 may track the candidate objects across consecutive image frames, estimate the real-world position of the candidate objects, and filter out those objects that are moving (which are unlikely to be traffic lights). In some embodiments, processing unit 110 may perform color analysis on the candidate objects and identify the relative position of the detected colors appearing inside possible traffic lights.

At step 562, processing unit 110 may analyze the geometry of a junction. The analysis may be based on any combination of: (i) the number of lanes detected on either side of vehicle 200, (ii) markings (such as arrow marks) detected on the road, and (iii) descriptions of the junction extracted from map data (such as data from map database 160). Processing unit 110 may conduct the analysis using information derived from execution of monocular analysis module 402. In addition, Processing unit 110 may determine a correspondence between the traffic lights detected at step 560 and the lanes appearing near vehicle 200.

As vehicle 200 approaches the junction, at step 564, processing unit 110 may update the confidence level associated with the analyzed junction geometry and the detected traffic lights. For instance, the number of traffic lights estimated to appear at the junction as compared with the number actually appearing at the junction may impact the confidence level. Thus, based on the confidence level, processing unit 110 may delegate control to the driver of vehicle 200 in order to improve safety conditions. By performing steps 560, 562, and 564, processing unit 110 may identify traffic lights appearing within the set of captured images and analyze junction geometry information. Based on the identification and the analysis, processing unit 110 may cause one or more navigational responses in vehicle 200, as described in connection with FIG. 5A, above.

FIG. 5E is a flowchart showing an exemplary process 500E for causing one or more navigational responses in vehicle 200 based on a vehicle path, consistent with the disclosed embodiments. At step 570, processing unit 110 may construct an initial vehicle path associated with vehicle 200. The vehicle path may be represented using a set of points expressed in coordinates (x, z), and the distance di between two points in the set of points may fall in the range of 1 to 5 meters. In one embodiment, processing unit 110 may construct the initial vehicle path using two polynomials, such as left and right road polynomials. Processing unit 110 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. In another embodiment, processing unit 110 may use one polynomial and an estimated lane width to offset each point of the vehicle path by half the estimated lane width plus a predetermined offset (e.g., a smart lane offset).

At step 572, processing unit 110 may update the vehicle path constructed at step 570. Processing unit 110 may reconstruct the vehicle path constructed at step 570 using a higher resolution, such that the distance dk between two points in the set of points representing the vehicle path is less than the distance di described above. For example, the distance dk may fall in the range of 0.1 to 0.3 meters. Processing unit 110 may reconstruct the vehicle path using a parabolic spline algorithm, which may yield a cumulative distance vector S corresponding to the total length of the vehicle path (i.e., based on the set of points representing the vehicle path).

At step 574, processing unit 110 may determine a look-ahead point (expressed in coordinates as (x1, z1)) based on the updated vehicle path constructed at step 572. Processing unit 110 may extract the look-ahead point from the cumulative distance vector S, and the look-ahead point may be associated with a look-ahead distance and look-ahead time. The look-ahead distance, which may have a lower bound ranging from 10 to 20 meters, may be calculated as the product of the speed of vehicle 200 and the look-ahead time. For example, as the speed of vehicle 200 decreases, the look-ahead distance may also decrease (e.g., until it reaches the lower bound). The look-ahead time, which may range from 0.5 to 1.5 seconds, may be inversely proportional to the gain of one or more control loops associated with causing a navigational response in vehicle 200, such as the heading error tracking control loop. For example, the gain of the heading error tracking control loop may depend on the bandwidth of a yaw rate loop, a steering actuator loop, car lateral dynamics, and the like. Thus, the higher the gain of the heading error tracking control loop, the lower the look-ahead time.

At step 576, processing unit 110 may determine a heading error and yaw rate command based on the look-ahead point determined at step 574. Processing unit 110 may determine the heading error by calculating the arctangent of the look-ahead point, e.g., arctan (x1/z1). Processing unit 110 may determine the yaw rate command as the product of the heading error and a high-level control gain. The high-level control gain may be equal to: (2/look-ahead time), if the look-ahead distance is not at the lower bound. Otherwise, the high-level control gain may be equal to: (2*speed of vehicle 200/look-ahead distance).

FIG. 5F is a flowchart showing an exemplary process 500F for determining whether a leading vehicle is changing lanes, consistent with the disclosed embodiments. At step 580, processing unit 110 may determine navigation information associated with a leading vehicle (e.g., a vehicle traveling ahead of vehicle 200). For example, processing unit 110 may determine the position, velocity (e.g., direction and speed), and/or acceleration of the leading vehicle, using the techniques described in connection with FIGS. 5A and 5B, above. Processing unit 110 may also determine one or more road polynomials, a look-ahead point (associated with vehicle 200), and/or a snail trail (e.g., a set of points describing a path taken by the leading vehicle), using the techniques described in connection with FIG. 5E, above.

At step 582, processing unit 110 may analyze the navigation information determined at step 580. In one embodiment, processing unit 110 may calculate the distance between a snail trail and a road polynomial (e.g., along the trail). If the variance of this distance along the trail exceeds a predetermined threshold (for example, 0.1 to 0.2 meters on a straight road, 0.3 to 0.4 meters on a moderately curvy road, and 0.5 to 0.6 meters on a road with sharp curves), processing unit 110 may determine that the leading vehicle is likely changing lanes. In the case where multiple vehicles are detected traveling ahead of vehicle 200, processing unit 110 may compare the snail trails associated with each vehicle. Based on the comparison, processing unit 110 may determine that a vehicle whose snail trail does not match with the snail trails of the other vehicles is likely changing lanes. Processing unit 110 may additionally compare the curvature of the snail trail (associated with the leading vehicle) with the expected curvature of the road segment in which the leading vehicle is traveling. The expected curvature may be extracted from map data (e.g., data from map database 160), from road polynomials, from other vehicles' snail trails, from prior knowledge about the road, and the like. If the difference in curvature of the snail trail and the expected curvature of the road segment exceeds a predetermined threshold, processing unit 110 may determine that the leading vehicle is likely changing lanes.

In another embodiment, processing unit 110 may compare the leading vehicle's instantaneous position with the look-ahead point (associated with vehicle 200) over a specific period of time (e.g., 0.5 to 1.5 seconds). If the distance between the leading vehicle's instantaneous position and the look-ahead point varies during the specific period of time, and the cumulative sum of variation exceeds a predetermined threshold (for example, 0.3 to 0.4 meters on a straight road, 0.7 to 0.8 meters on a moderately curvy road, and 1.3 to 1.7 meters on a road with sharp curves), processing unit 110 may determine that the leading vehicle is likely changing lanes. In another embodiment, processing unit 110 may analyze the geometry of the snail trail by comparing the lateral distance traveled along the trail with the expected curvature of the snail trail. The expected radius of curvature may be determined according to the calculation: (δz2+δx2)/2/(δx), where δx represents the lateral distance traveled and δz represents the longitudinal distance traveled. If the difference between the lateral distance traveled and the expected curvature exceeds a predetermined threshold (e.g., 500 to 700 meters), processing unit 110 may determine that the leading vehicle is likely changing lanes. In another embodiment, processing unit 110 may analyze the position of the leading vehicle. If the position of the leading vehicle obscures a road polynomial (e.g., the leading vehicle is overlaid on top of the road polynomial), then processing unit 110 may determine that the leading vehicle is likely changing lanes. In the case where the position of the leading vehicle is such that, another vehicle is detected ahead of the leading vehicle and the snail trails of the two vehicles are not parallel, processing unit 110 may determine that the (closer) leading vehicle is likely changing lanes.

At step 584, processing unit 110 may determine whether or not leading vehicle 200 is changing lanes based on the analysis performed at step 582. For example, processing unit 110 may make the determination based on a weighted average of the individual analyses performed at step 582. Under such a scheme, for example, a decision by processing unit 110 that the leading vehicle is likely changing lanes based on a particular type of analysis may be assigned a value of “1” (and “0” to represent a determination that the leading vehicle is not likely changing lanes). Different analyses performed at step 582 may be assigned different weights, and the disclosed embodiments are not limited to any particular combination of analyses and weights.

FIG. 6 is a flowchart showing an exemplary process 600 for causing one or more navigational responses based on stereo image analysis, consistent with disclosed embodiments. At step 610, processing unit 110 may receive a first and second plurality of images via data interface 128. For example, cameras included in image acquisition unit 120 (such as image capture devices 122 and 124 having fields of view 202 and 204) may capture a first and second plurality of images of an area forward of vehicle 200 and transmit them over a digital connection (e.g., USB, wireless, Bluetooth, etc.) to processing unit 110. In some embodiments, processing unit 110 may receive the first and second plurality of images via two or more data interfaces. The disclosed embodiments are not limited to any particular data interface configurations or protocols.

At step 620, processing unit 110 may execute stereo image analysis module 404 to perform stereo image analysis of the first and second plurality of images to create a 3D map of the road in front of the vehicle and detect features within the images, such as lane markings, vehicles, pedestrians, road signs, highway exit ramps, traffic lights, road hazards, and the like. Stereo image analysis may be performed in a manner similar to the steps described in connection with FIGS. 5A-5D, above. For example, processing unit 110 may execute stereo image analysis module 404 to detect candidate objects (e.g., vehicles, pedestrians, road marks, traffic lights, road hazards, etc.) within the first and second plurality of images, filter out a subset of the candidate objects based on various criteria, and perform multi-frame analysis, construct measurements, and determine a confidence level for the remaining candidate objects. In performing the steps above, processing unit 110 may consider information from both the first and second plurality of images, rather than information from one set of images alone. For example, processing unit 110 may analyze the differences in pixel-level data (or other data subsets from among the two streams of captured images) for a candidate object appearing in both the first and second plurality of images. As another example, processing unit 110 may estimate a position and/or velocity of a candidate object (e.g., relative to vehicle 200) by observing that the object appears in one of the plurality of images but not the other or relative to other differences that may exist relative to objects appearing if the two image streams. For example, position, velocity, and/or acceleration relative to vehicle 200 may be determined based on trajectories, positions, movement characteristics, etc. of features associated with an object appearing in one or both of the image streams.

At step 630, processing unit 110 may execute navigational response module 408 to cause one or more navigational responses in vehicle 200 based on the analysis performed at step 620 and the techniques as described above in connection with FIG. 4. Navigational responses may include, for example, a turn, a lane shift, a change in acceleration, a change in velocity, braking, and the like. In some embodiments, processing unit 110 may use data derived from execution of velocity and acceleration module 406 to cause the one or more navigational responses. Additionally, multiple navigational responses may occur simultaneously, in sequence, or any combination thereof.

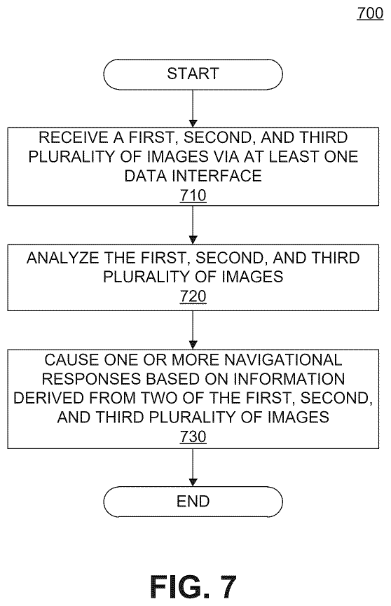

FIG. 7 is a flowchart showing an exemplary process 700 for causing one or more navigational responses based on an analysis of three sets of images, consistent with disclosed embodiments. At step 710, processing unit 110 may receive a first, second, and third plurality of images via data interface 128. For instance, cameras included in image acquisition unit 120 (such as image capture devices 122, 124, and 126 having fields of view 202, 204, and 206) may capture a first, second, and third plurality of images of an area forward and/or to the side of vehicle 200 and transmit them over a digital connection (e.g., USB, wireless, Bluetooth, etc.) to processing unit 110. In some embodiments, processing unit 110 may receive the first, second, and third plurality of images via three or more data interfaces. For example, each of image capture devices 122, 124, 126 may have an associated data interface for communicating data to processing unit 110. The disclosed embodiments are not limited to any particular data interface configurations or protocols.

At step 720, processing unit 110 may analyze the first, second, and third plurality of images to detect features within the images, such as lane markings, vehicles, pedestrians, road signs, highway exit ramps, traffic lights, road hazards, and the like. The analysis may be performed in a manner similar to the steps described in connection with FIGS. 5A-5D and 6, above. For instance, processing unit 110 may perform monocular image analysis (e.g., via execution of monocular image analysis module 402 and based on the steps described in connection with FIGS. 5A-5D, above) on each of the first, second, and third plurality of images. Alternatively, processing unit 110 may perform stereo image analysis (e.g., via execution of stereo image analysis module 404 and based on the steps described in connection with FIG. 6, above) on the first and second plurality of images, the second and third plurality of images, and/or the first and third plurality of images. The processed information corresponding to the analysis of the first, second, and/or third plurality of images may be combined. In some embodiments, processing unit 110 may perform a combination of monocular and stereo image analyses. For example, processing unit 110 may perform monocular image analysis (e.g., via execution of monocular image analysis module 402) on the first plurality of images and stereo image analysis (e.g., via execution of stereo image analysis module 404) on the second and third plurality of images. The configuration of image capture devices 122, 124, and 126—including their respective locations and fields of view 202, 204, and 206—may influence the types of analyses conducted on the first, second, and third plurality of images. The disclosed embodiments are not limited to a particular configuration of image capture devices 122, 124, and 126, or the types of analyses conducted on the first, second, and third plurality of images.

In some embodiments, processing unit 110 may perform testing on system 100 based on the images acquired and analyzed at steps 710 and 720. Such testing may provide an indicator of the overall performance of system 100 for certain configurations of image capture devices 122, 124, and 126. For example, processing unit 110 may determine the proportion of “false hits” (e.g., cases where system 100 incorrectly determined the presence of a vehicle or pedestrian) and “misses.”

At step 730, processing unit 110 may cause one or more navigational responses in vehicle 200 based on information derived from two of the first, second, and third plurality of images. Selection of two of the first, second, and third plurality of images may depend on various factors, such as, for example, the number, types, and sizes of objects detected in each of the plurality of images. Processing unit 110 may also make the selection based on image quality and resolution, the effective field of view reflected in the images, the number of captured frames, the extent to which one or more objects of interest actually appear in the frames (e.g., the percentage of frames in which an object appears, the proportion of the object that appears in each such frame, etc.), and the like.

In some embodiments, processing unit 110 may select information derived from two of the first, second, and third plurality of images by determining the extent to which information derived from one image source is consistent with information derived from other image sources. For example, processing unit 110 may combine the processed information derived from each of image capture devices 122, 124, and 126 (whether by monocular analysis, stereo analysis, or any combination of the two) and determine visual indicators (e.g., lane markings, a detected vehicle and its location and/or path, a detected traffic light, etc.) that are consistent across the images captured from each of image capture devices 122, 124, and 126. Processing unit 110 may also exclude information that is inconsistent across the captured images (e.g., a vehicle changing lanes, a lane model indicating a vehicle that is too close to vehicle 200, etc.). Thus, processing unit 110 may select information derived from two of the first, second, and third plurality of images based on the determinations of consistent and inconsistent information.

Navigational responses may include, for example, a turn, a lane shift, a change in acceleration, and the like. Processing unit 110 may cause the one or more navigational responses based on the analysis performed at step 720 and the techniques as described above in connection with FIG. 4. Processing unit 110 may also use data derived from execution of velocity and acceleration module 406 to cause the one or more navigational responses. In some embodiments, processing unit 110 may cause the one or more navigational responses based on a relative position, relative velocity, and/or relative acceleration between vehicle 200 and an object detected within any of the first, second, and third plurality of images. Multiple navigational responses may occur simultaneously, in sequence, or any combination thereof.

### Anomaly Detection

Autonomous vehicle (AV) systems, whether partially or fully autonomous, may be configured to navigate based on various sources of information alone or in combination. For example, AVs may navigate relative to mapped information (e.g., REM maps that store 3D representations of drivable paths for each available lane of travel for road segments, junctions, navigable areas, etc.; representations and locations of traffic lights, traffic signs, road edges, lane markings, and various other types of road topography; and navigation assistance information such as traffic light relevancy, lane priority, road geometry/dimensions relative to a drivable path, etc.).

AVs may also navigate relative to information gathered by sensors onboard a host vehicle. Such sensors may include one or more cameras (e.g., a surround camera system), LIDARs, RADARs, etc. Collected sensed information may be aggregated together, distilled, etc. to provide a host vehicle navigation system with a sensing state at a particular snap shot in time. Such a sensing state may indications of object detections (e.g., target vehicles, pedestrians, road debris, road topography, etc.) in an environment of a host vehicle and may also include spatial information associated with detected objects. Such spatial information may include any or all of: object dimensions, bounding box dimensions, height above a road surface, relative spacing between detected objects, depth/range information, 3D point coordinates for one or more points associated with detected objects, etc.

To make navigational decisions, the available sensing state (along with mapped information, if available) may be supplied to a driving policy, one or more end-to-end systems, or other type of system configured to generate planned navigational actions based on a vehicle sensing state. Such a driving policy, end-to-end system, etc. may generate a planned navigational action to be implemented by a vehicle system (e.g., steering, braking, accelerator, etc.) to advance a navigational goal of the AV (e.g., moving from a current location toward a planned destination) while operating safely relative to objects and situations represented by the sensing state. In some cases, such a driving policy or end-to-end system may be configured to impose certain navigational constraints (e.g., minimum safety distance to maintain relative to target vehicles, minimum buffer distance relative to pedestrians, etc.) in generating the planned navigation actions.

For various tasks associated with providing the vehicle sensing state, interpreting the sensing state, generating planned navigational actions, etc., modern AVs may include many types of deep learning models (e.g., trained models, trained neural networks, trained GNNs, transformer-based networks, etc.). Such models may assist in performing a host of functions, such as object identification, situation identification/recognition, identifying or interpreting semantic relationships represented in a scene, generating planned trajectories in view of sensed targets and road topography, validating planned trajectories, among many other tasks. Such models may also be useful in generating appropriate navigational actions in response to detected vehicles, pedestrians, traffic light states, traffic signs, etc.

Under normal conditions and situations, trained models may operate with extremely high precision and low failure rates. For example, trained models may become extremely proficient in performing tasks that are represented in the training data sets used to train those models. Even where the input to a model falls outside of the data represented by training data sets used to train the model, but where the input is similar to the training data sets, trained models may be proficient at “extrapolating” to predict a correct answer based on the similarity of the new input to data sets it trained experienced during training.

Edge cases may be more difficult for trained models to handle. For example, a significant challenge for decision-making systems that rely upon sensor input is recognizing and appropriately responding to anomalous situations. Trained models (e.g., neural networks, etc.) may be trained relative to anomalous edge cases, but it is difficult or impossible to collect or generate training data representative of the virtually infinite number of possible anomalous situations that may be encountered (e.g., towed vehicles, backward facing vehicles carried as cargo, pedestrians lying on a road surface, pedestrians standing atop a vehicle, a mattress strapped to a vehicle roof and waving in the wind, sun ray patterns on an acquired image, motorcycles riding between lanes, etc.).

One approach to the challenge of improving trained model performance in recognizing anomalous situations is simply a brute force method of training the model(s) with ever increasing numbers of edge cases indicative of anomalous situations. Every time there is a failure of an AV system to identify or respond as desired to a road feature or situation, new training data may be generated to simulate that type of feature or situation and variations of the same. No matter how many training examples are provided, however, there will still remain anomalous situations falling outside of the network's training, which may ultimately limit the performance capability of the trained model(s).

The presently disclosed embodiments approach this challenge from a different direction. Rather than training the system to positively identify what is an anomalous situation (which would require iteratively training the network to recognize a virtually infinite number of specific types of anomalous situations/objects), the present system may be trained (e.g., using training samples representative of normal situations/objects) to recognize whether a particular sample falls within what is considered normal, based on its training, or whether the sample exhibits one or more features that cause the sample to fall outside of what is considered to be normal. For example, a normal region may be represented by a predetermined embedding space distribution enclosing encodings (e.g., feature vectors) associated with normally occurring objects, scenarios, etc. If a particular input sample's encoding falls outside of this predetermined embedding space distribution, the system may determine that the input sample represents an anomalous object, scenario, etc. In this way, the present system can be trained on readily available “normal” training data set samples, yet can recognize more than just a finite number of predetermined anomalous situations/objects. Rather, the present system has the potential to recognize/identify an infinite number of anomalous situations/objects based on a determination or inference that those situations/objects do not fall within what the network has been trained to recognize as “normal.”

One example embodiment includes a system for navigating a host vehicle relative to a road segment (e.g., any section of road, junction, roundabout, navigable area, etc.). The system comprises at least one processor comprising circuitry and a memory, wherein the memory includes instructions executable by the circuitry. The processor and memory may include any of the computing hardware and memory units described in the sections above. When executed by the processor (or at least one processor), the instructions are configured to cause the processor to: receive a captured image acquired by a camera onboard the host vehicle; generate a representation in embedding space of at least a portion of the captured image; determine whether the representation in embedding space of the at least a portion of the captured image falls outside of a predetermined embedding space region, wherein the predetermined embedding space region is defined as a non-anomalous embedding space region; determine a navigational action for the host vehicle based on a determination that the representation in embedding space of the at least a portion of the captured image falls outside of the predetermined embedding space region; and cause at least one system associated with the host vehicle to implement the navigational action.

An embedding space, or latent space, may be considered as a mathematical construct in which real-world data may be encoded, compressed, simplified, etc. (e.g., using feature vector representations of real-world data). The latent space is a lower-dimensional, continuous space where the input data is encoded. In an embedding space, similar items/features/object representations are positioned closer to one another than less similar items, such that each item has a specific place based on its characteristics. In this way, an embedding space may be used to organize information efficiently. Because of the focus on similarity and distance, and by mapping high-dimensional data to a lower-dimensional space, use of an embedding space may reduce computational and memory requirements while enhancing model efficiency. The embedding space also retains semantic and syntactic relationships, enabling deep-learning models to grasp real-world data domains more effectively.

The process of creating an embedding space involves transforming raw data into a structured format that facilitates efficient analysis and pattern recognition. This transformation typically converts input elements, such as images or portions of images, into numerical vectors (feature vectors) that capture characteristics of the images or image portions. Each image (or image portion) is provided to an encoder that maps image features to high-dimensional vectors where semantic relationships are preserved. This mapping allows algorithms, trained models, etc. to interpret image data based on proximity and orientation within the embedding space.

The similarity between images or image segments may be indicated by the closeness (or distance) between their vector representations in embedding space. Distance in embedding space may be determined using various techniques. For example, a Euclidean distance between vectors may be determined. This distance represents a “straight-line” distance between two vectors. Cosine similarity between vectors may also be determined based on the angular separation between two vectors. Cosine similarity may offer an advantage of being less sensitive to differences in vector magnitudes. Smaller distances in embedding space between encoded vectors generally indicate greater degrees of similarity between the corresponding real-world data (e.g., images or image segments) and/or higher degrees of semantic relationship.

In some cases, dedicated encoders may be used to generate feature vectors based on input images or image segments. The representations of images or image segments may also be performed by using a trained model. There are also various types of encoders, such as variational autoencoders (VAEs), which are a type of trained model/neural network that may be especially useful for learning efficient data representations for dimensionality reduction, feature learning, etc.

Autoencoders may include an encoder and a decoder. The encoder compresses the input data into a lower-dimensional latent space, and the decoder reconstructs the original data from this compressed representation. During training of a variational autoencoder, or other type of model, an objective is to minimize the difference between the input and the reconstructed output. For example, as represented in FIG. 8, training of a VAE may include presenting the model with an image 810 (or portion of a captured image) as input 812. The model, including encoder 814, is forced to encode input images (such as input image 810) into a compressed embedding space 816. The model, including decoder 818, is also forced to decode the compressed image or image segments from embedding space 816 to generate corresponding image outputs, such as output image 820. The output images may be compared to the input images. If there are differences, the model may be penalized, and the weights may be refined. The process may continue iteratively until the output image(s) (after decoding) matches the input image(s) (before encoding). In this way, the network learns to generate accurate compressed representations of input images or image segments. The input images/image segments may be compressed into vector space representations according to:

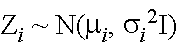

The sparse vector space representations form a distribution (e.g., a multi-dimensional distribution, such as a Gaussian distribution) across vector space. This distribution can be learned by the model such that during operation in the wild, the trained model may use the learned distribution as a reference for evaluating whether or not a received image or image segment includes scene or object representations, etc., that when compressed into the sparse vector space, are represented by a feature vector, for example, that falls outside of a “normal” area of the distribution. That is, if an encoded input image/image segment is represented by a feature vector, score, value, etc. that falls outside of a predetermined region of the embedding space distribution representative of normal scenes or objects, the model may return an output indicating that the input image/image segment represents an anomaly or anomalous scenario.

The learned distribution in vector space of encountered images/image segments may be representative of types of scenes or objects, etc., the model is expected to encounter during operation. For example, for an autonomous vehicle application, the learned distribution (generated through training of the model) may be associated with types of scenes expected to be encountered by an autonomous vehicle navigation system. Such scenes may include representations of an environment forward of the vehicle, to the sides of the vehicle, to the rear of the vehicle, or 360° around the vehicle etc. Additionally, such scenes may include representations of faces (e.g., faces of a driver), a person's joint visibility information, road signs, road marking, road edges, road signs, road surfaces, road surface markings, and various other types of scenes or objects, etc. normally found in the environment of navigating vehicles. The trained neural network learns what distribution or distributions represent “normal” scenes or objects, such that when embeddings are generated that are outside of this normal distribution or distributions, the system may indicate that an abnormal scene or object has been encountered.

As a brief example of how the trained model may operate, if the model's training data set included input image 810, then when the model operates in the wild (e.g., as part of a vehicle navigation system), if the model receives an input of a similar scene that includes the sign represented in input image 810, the model would almost assuredly return an indication that the input image does not represent an anomalous scene. The model's training would also likely include many hundreds or thousands (or more) of other types of traffic signs typically experienced during vehicle navigation. As a result, input images including representations of any of these signs would also likely result in an output from the trained model indicating that the input image does not represent an anomalous object/scenario. Further, however, it is possible that an input image represents a road sign that was not included in the data set used to train the model. Even in those cases, as long as the new road sign was similar enough to the model's training data (e.g., if an encoding of the new sign fell within a predetermined range of the embedding space distributed mathematically deemed as representing a “normal” range), the trained model would likely indicate that the new sign was not anomalous. On the other hand, if the trained model received an input very similar to the input image 810, except that the sign included yellow spraypainted graffiti, the model may determine that an encoding for such an image input falls outside of the “normal” range of the embedding space distribution and may return an output indicating that the input image represents an anomaly or anomalous scenario.

As noted above, the trained model may be forced to generate an embedding space represented by a predetermined distribution (e.g., a Gaussian distribution, or other type of probabilistic distribution). The predetermined embedding space region used to designate normal versus anomalous embeddings (and, therefore, input images, features represented by input images, etc.) may be selectable in size and may correspond to a predetermined sub-region of a probabilistic distribution.

Using a thresholding approach, the trained model can determine whether a particular input image falls within a normal distribution of represented subjects (e.g., a normal face, sign, etc.) or whether a subject represented in the input image falls outside of the normal distribution range. This normal distribution range may be set by one or more thresholds. The thresholds may be selected (e.g., by a model creator, user, etc.) to tune the normal/not normal output sensitivity of the trained model. In some cases, the performance of the trained model may be tuned such that a pedestrian in a crosswalk returns a normal indicator, while the same pedestrian lying in the crosswalk may return an anomalous indicator. Using the thresholding approach, the performance of the trained model may be tuned such that the model returns a normal indication (i.e., not anomalous) both in response to input images that include representations of live human beings and in response to input images that include representations of crash test dummies. In other words, while the trained model may be capable of distinguishing between live humans and dummies (e.g., based on the separation in embedding space of their corresponding embeddings), there may be situations (e.g., vehicle safety testing) where it may be desirable to classify non-human drivers/passengers as “normal.”

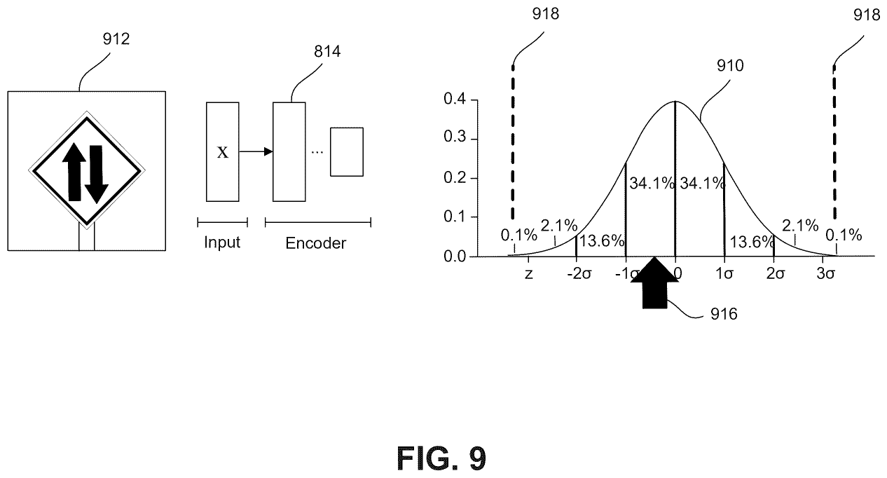

As noted, the trained model may be used to identify anomalous objects, scenarios, etc. based on whether embeddings for images or image segments including representations of such objects/scenarios falls outside of a predetermined embedding space region, wherein the predetermined embedding space region is defined as a non-anomalous embedding space region. There are various thresholding techniques that may be used to define the non-anomalous embedding space region. In some cases, the thresholding technique selected may depend on whether an embedding space is represented as a probabilistic distribution and, if so, the type of probabilistic distribution employed. In an example where the embedding space is represented as a Gaussian distribution 910, as shown in FIG. 9, anomaly thresholding may be selected to capture within the “normal” range of the distribution any desired percentage of the embedding space. Such a “normal” range may be set by selecting threshold values at any desired standard deviation, σ, associated with the probability distribution. For example, as shown in FIG. 9, a threshold of σ (one standard deviation away from center) would establish about 68.2% of the embedding space as indicative of “normal” objects/scenarios, etc. A threshold of two standard deviations, 2σ, would capture about 95.4% of the embedding space in the “normal” region, and a threshold of three standard deviations, 3σ, would capture about 99.6% of the embedding space in the “normal” region. The selected thresholds need not be limited to whole standard deviations. Rather, any desired percentage or y value associated with the probabilistic distribution may be selected for use as the “normal” range threshold. For example, a threshold of 99.9% could be established (e.g., during model generation or during model use, etc.) as establishing the normal region of the embedding space. In such a case, all but the extreme tail ends of the Gaussian shown in FIG. 9 would be representative of the normal embedding space. Any encoded output falling outside of the established “normal” thresholds (e.g., thresholds 918 indicating a normal embedding space sub-region encompassing about 99.8% of the embedding space) would be indicated as including an anomaly/anomalous scenario, etc. On the other hand, an image input, such as image 912, which includes a representation of a typical road sign indicating two-way traffic, may result in an encoder output that falls within the first standard deviation of the Gaussian distribution 910 (e.g., as indicated by arrow 916) would be indicated by the trained model as indicative of a normal object/scenario.

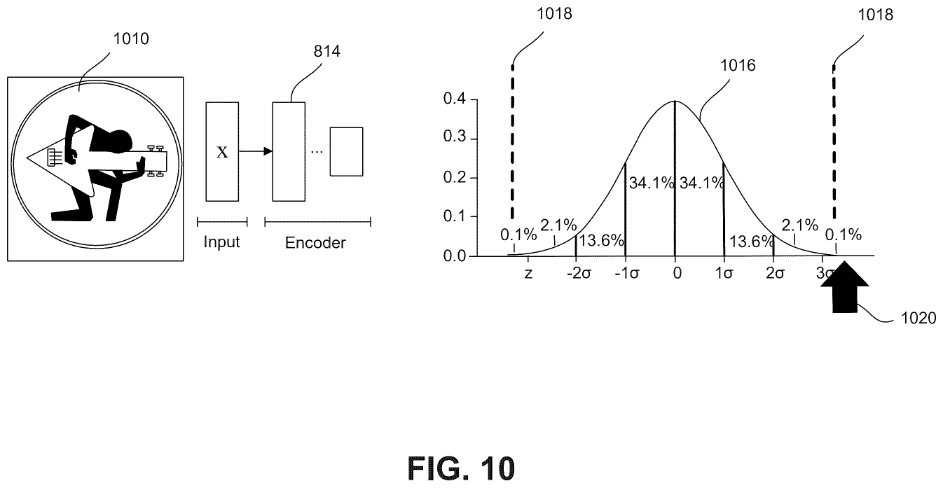

FIG. 10, in contrast, represents an example in which the trained model identifies an input image 1010 as including a sign identified as anomalous. For example, in response to receiving sign 1010 as input, encoder 814 generates an encoded embedding space value (e.g., feature vector, score, % value, etc.) near the tail end of Gaussian distribution 1016 as indicated by arrow 1020. In this instance, the encoded embedding space value represented by arrow 1020 falls outside of thresholds 1018 defining the “normal” sub-region of the embedding space. As a result, the trained model returns an output value (e.g., a Boolean value) indicating that the input image 1010 represents an anomalous object, scenario, etc.

The sensitivity of the trained model in identifying an anomaly may be controlled by varying the “normal” threshold. For example, as the threshold increases (e.g., higher standard deviations, higher percentage values, etc.), the trained model will become less sensitive to anomalies represented by an input image. On the other hand, as the threshold decreases (e.g., fewer standard deviations, lower percentage values, etc.), the trained model will become more sensitive to anomalies represented by an input image. Thus, a predetermined threshold for detecting anomalous events can be tuned to provide a desired sensitivity level. A higher sensitivity level may result in only a relatively focused region of the sparse vector space as being associated with “normal” events. A lower sensitivity level may result in a larger region of the sparse vector space as being associated with “normal” events. In some cases, it may be desired to tune the threshold to provide a relatively low sensitivity in order to limit the number of false alarms (e.g., “normal” situations being mis-identified as anomalous). In a particular example, the described system may be tuned such that test dummies are not identified as abnormal, which can be beneficial for conducting tests of a host vehicle navigation system. That is, while the system may recognize the difference between a live human and a test dummy, the system may be tuned with the sensitivity threshold such that for purposes of a navigation system test, the described system can be made to classify both humans and test dummies in the “normal” distribution space. In other words, the test dummies are not identified as abnormal, which could impact the results of a navigation system test.

Encoder 814 may be configured to generate any suitable output associated with establishing or referencing an embedding space. In some cases, encoder 814 may be configured to generate feature vectors, and the embedding space may be defined by a threshold distance relative to an embedding space reference (e.g., an embedding space origin). In such cases, “normal” feature vectors (and their corresponding input images) will correspond to those feature vectors that fall within a predetermined distance from an origin, for example (as determined using Euclidean distance, cosine similarity, or another technique). Those feature vectors that fall outside of the predetermined distance will indicate an anomaly or anomalous scenario represented in the corresponding input images. In other cases, encoder 814 may be configured to directly output a score or other indicator (e.g., a percentage value, etc.) relative to a probabilistic distribution representative of the embedding space. In still other cases, the encoder may encode an input image, compare the encoded value(s) to a predetermined embedding space (e.g., one determined during training), and return an output simply indicating whether the encoded value(s) fall inside or outside of the “normal” embedding space. It may also be possible to employ one or more additional software-based modules to assist in a determination of whether an encoded value, feature vector, etc. representative of an input image falls within a “normal” region of an embedding space.

As noted above, threshold values for use in tuning the sensitivity of the trained model may be user-selectable. As an example, a user may set the thresholds that define the “normal” range of the embedding space at any value that provides a desired performance level relative to encountered objects/scenarios. If the system indicates that certain objects or scenarios (e.g., crash dummies occupying a test vehicle) are anomalous, but the user wishes for those objects/scenarios to be classified as non-anomalous (normal), the user can increase the threshold values to expand the “normal” embedding space region. In this way, the normal embedding space region may correspond to a predetermined sub-region of the embedding space defined by at least one user-selectable parameter value. In some cases, the user-selectable parameter value is an embedding space distance indicator (e.g., a Euclidean distance, an angular cosine similarity value, etc.). In other cases, the user-selectable parameter value is a percentage value (or other type of value) associated with a probabilistic distribution representation of the embedding space.

Based on the output of the trained model, indicating whether an anomalous object or scenario has been encountered, the described host vehicle navigation system may determine a navigational action for the host vehicle. For example, the determined navigational action may be generated in response to a determination that a representation in embedding space of the at least a portion of a captured image falls outside of a predetermined embedding space region (e.g., a sub-region of the embedding space defined as representing “normal” objects/scenarios). Various navigational actions and types of navigational actions may be taken in response to a detected anomalous object, scenario, etc. In some cases, in response to a detected anomalous object or scenario, etc., the host vehicle navigation system may cause a braking system to slow or stop the host vehicle, an acceleration system to increase the speed of the vehicle, or a steering system change a heading direction of the host vehicle. In some cases, the planned navigational action, in response to a detected anomalous object/scenario, may include causing the host vehicle to maintain a current speed and heading direction. Additionally, or alternatively, a navigational action in response to a detected anomalous object/scenario may include generation of an audible or visual alert to be provided to an operator or passenger of the host vehicle (e.g., via one or more speakers, displays, interactive screens, etc.).

A detection of an anomalous object or scenario, etc., may be used as a trigger for causing the host vehicle navigation system (e.g., a policy component of the host vehicle navigation system) to take one or more additional actions. For example, the host vehicle navigation system may perform additional analysis with respect to the outputs of one or more sensors onboard the host vehicle. For example, acquired images from a camera or points clouds generated by one or more of a LIDAR or RADAR may be analyzed to determine motion characteristics of an anomalous object or objects in a scene. This additional analysis may enable the host vehicle navigation system to generate an appropriate planned navigational action (e.g., maintaining heading and speed where the anomalous object is determined to be moving away from the host vehicle).

Any input image or portion of an input image may be encoded by the disclosed trained model and represented in embedding space. In some cases, the encoded image represented in embedding space may correspond to an acquired image representative of a full field of view (FOV) of a camera onboard a host vehicle. In other cases, however, a region of interest in an acquired image may be identified, and the image data from the identified region of interest may be encoded into embedding space. Such a region of interest may be identified by one or more trained models or image segmentation techniques and may include, among other things, a representation of a traffic sign, road sign, traffic light, target vehicle, debris, object on a road surface, object adjacent to a road, road barrier structure, pedestrians, bicyclist, etc.

The disclosed embodiments may be useful for enabling a host vehicle navigation system to identify and respond to virtually any type of anomalous object, situation, or scenario that may be encountered. Indeed, the disclosed embodiments, including the described trained neural networks, may be configured to recognize virtually any type of anomalous situation or object outside of normal expectations. The section below discusses just a few examples of the types of anomalous scenarios that the disclosed embodiments may encounter.

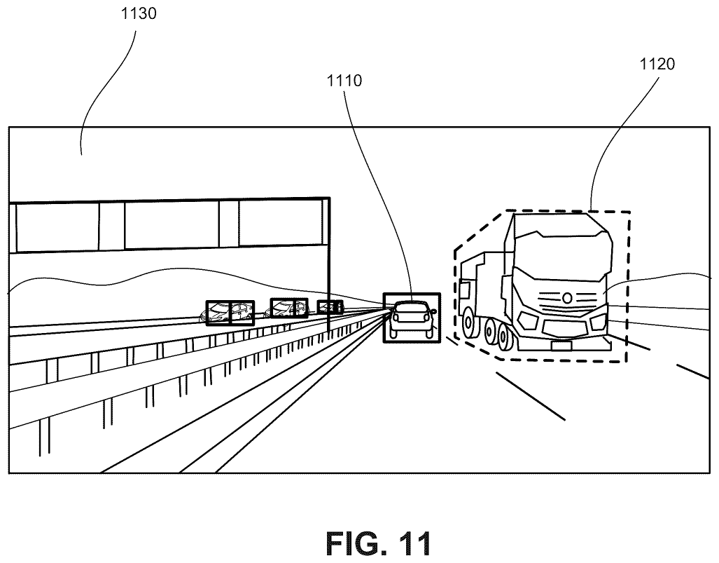

FIG. 11 represents a scenario that may be difficult for autonomous navigation systems to identify and navigate appropriately. In this example, a host vehicle is traveling along a section of highway, and two target vehicles have been detected forward of the host vehicle. A first target vehicle 1110 is directly ahead of the host vehicle and is traveling in the same lane as the host vehicle. A second target vehicle 1120 is ahead and to the right of the host vehicle. Target vehicle 1120 has been identified by the navigation system (as indicated by the dashed line bounding box), but target vehicle 1120 includes both a carrying vehicle and a reverse-facing, carried vehicle. Because the carried vehicle is facing the host vehicle (e.g., features typically associated with the front of a vehicle (headlights, windscreen, grill, etc.) are visible to the host vehicle, the host vehicle navigation system may reach an initial determination that the vehicle 1120 is a single vehicle traveling toward the host vehicle. Such a scenario, while rare on a highway section, can occur and can be hazardous. If a host vehicle encounters a target vehicle traveling in a wrong direction opposite to the host vehicle on a section of highway, a reasonable response may include steering the host vehicle toward the shoulder, slowing the host vehicle, or stopping the host vehicle. It may be extremely uncomfortable, and potentially dangerous, for a host vehicle to maintain its course and speed in such a situation.

In the situation depicted by FIG. 11, however, the carried vehicle is moving together with the carrying vehicle and in the same direction as the host vehicle. As a result, target vehicle 1120 likely poses no more risk to the host vehicle than target vehicle 1110. In such a situation, it would be undesirable for the host vehicle to execute the type of evasive maneuvers that may be appropriate in a situation where target vehicle 1120 was traveling in a direction opposite to the host vehicle.

The disclosed embodiments may enable a host vehicle navigation system to determine and implement an appropriate response to this unusual situation. For example, upon receiving an acquired image frame 1130, the encoder of the disclosed trained model may encode image frame 1130 (or a sub-section of image 1130, such as a region of interest including the representation of target vehicle 1120) into embedding space and determine whether image 1130 includes a representation of an anomalous object or an anomalous scenario. In this example, the trained model may return an indication that the representation of target vehicle 1120 (or the apparent scenario represented by image 1130 of a large truck potential driving toward the host vehicle along a divided highway) represents an anomalous situation. In response, the host vehicle navigation system may determine one or more navigational actions for the host vehicle based on the determination that the representation in embedding space of the at least a portion of the captured image 1130 falls outside of a predetermined “normal” embedding space region.

In some cases, in response to an indication that the environment of the host vehicle includes an anomalous object/scenario, the host vehicle system may perform additional analysis to better assess the situation. In the example of FIG. 11, the host vehicle navigation system may access an output of one or more other systems/sensors to assess motion characteristics of objects in the environment of the host vehicle. Such an assessment may be performed in a variety of ways. In some cases, such motion characteristic information may be determined and stored as a series of image frames are captured relative to the host vehicle environment (e.g., using structure in motion calculation techniques; forward warping of a captured image, while subtracting the effects of host vehicle ego motion, to compare with a later captured image and reveal object motion separate from the effects of the host vehicle ego motion; using one or more trained models to infer motion characteristics of an object based on known host vehicle ego motion and image locations of the object in two or more captured image frames; etc.). In such cases, upon receiving an indication of an anomalous situation, the host vehicle navigation system may access the stored motion information to determined whether the motion of target vehicle 1120 poses a threat to the host vehicle. In other cases, such analyses can be performed on demand in response to receiving that anomalous situation indicator.

In still other cases, sensor outputs available to the host vehicle navigation system may be analyzed to determine motion characteristics of target vehicle 1120 and whether target vehicle poses a threat (such as a head-on collision threat) to the host vehicle. Such sensors may include LIDAR information, RADAR information, etc. In the actual situation depicted by image frame 1130, an indication by the trained system of an anomalous scenario and review of the motion characteristics of target vehicle 1120 (assuming that target vehicle 1120 is moving in the same direction as the host vehicle and with a similar speed) would likely result in a planned navigational action for the host vehicle that includes maintaining a course and speed of the host vehicle. On the other hand, if review of the motion characteristics of target vehicle 1120 indicated that target vehicle 1120, while moving in the same direction as the host vehicle, was moving significantly slower than the host vehicle, the host vehicle navigation system may cause the host vehicle to slow and/or steer slightly to the left to increase a buffer distance between the host vehicle and target vehicle 1120.

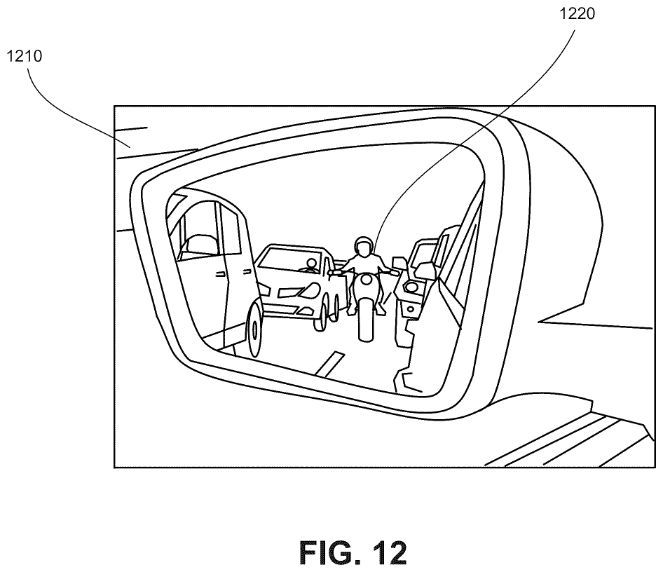

FIG. 12 represents another anomalous situation for which the disclosed embodiments may assist in determining an appropriate navigational response. In this example, the disclosed trained model may be provided a captured image 1210 as input. The trained model may return an indication that a generated embedding associated with captured image 1210 falls outside of a predetermined “normal” embedding space sub-region (e.g., because image 1210 includes a representation of a motorcycle 1220 riding between lanes and between lines of target vehicles on either side of the motorcycle). In response, and perhaps based on analysis of sensor output or motion determination techniques, as described above, the host vehicle navigation system may determine that not only is motorcycle 1220 riding between lanes, but also that motorcycle 1220 is advancing toward the host vehicle from behind the host vehicle. In such a situation and based on the anomalous scenario determination and motion characteristics of motorcycle 1220, the host vehicle navigation system may determine a navigational action for the host vehicle. In this example, the navigational action may include maintaining a speed and heading for the host vehicle, steering the host vehicle slightly in a direction away from the motorcycle to increase a buffer distance between the host vehicle and the motorcycle, etc.

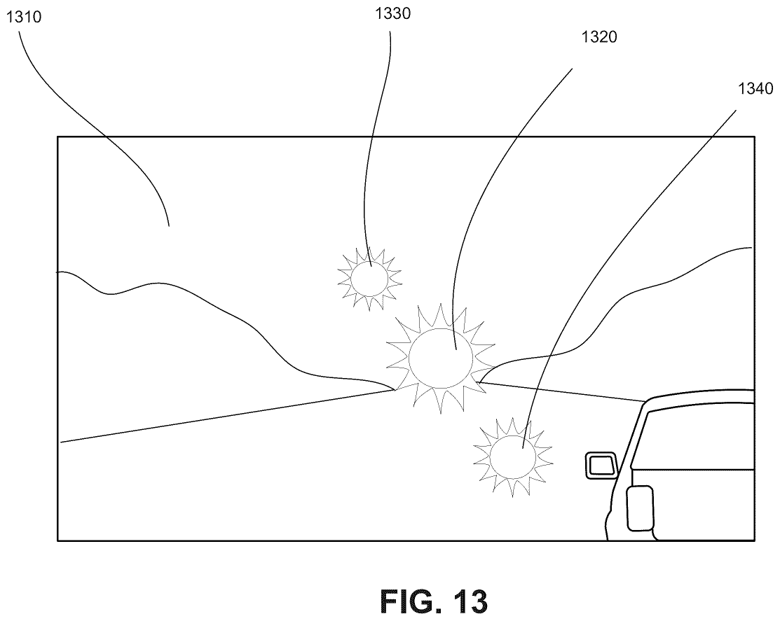

FIG. 13 represents another anomalous situation for which the disclosed embodiments may assist in determining an appropriate navigational response. In this example, the disclosed trained model may be provided a captured image 1310 as input. The trained model may return an indication that a generated embedding associated with captured image 1310 falls outside of a predetermined “normal” embedding space sub-region (e.g., because image 1310 includes a representation of the sun 1320 and a number of sun-associated image effects 1330, 1340 that may obscure one or more target objects/vehicles ahead of the host vehicle). If such effects are unrecognized, missed detections and/or mis-identification of objects represented in the one or more input images (among other adverse effects) may occur. In response, the host vehicle navigation system may analyze sensor outputs (e.g., a RADAR output, etc.) to assess whether target objects/vehicles may exist ahead of the host vehicle. If it can be confirmed, e.g., based on analysis of the additional sensor output(s) that no hazards exist ahead of the host vehicle, the host vehicle navigation system may generate a planned navigational action for the host vehicle including maintaining a current speed and heading direction. On the other hand, based on the presence of image effects 1330, 1340 in captured image 1310, the host vehicle navigation system may determine a navigational action for the host vehicle that includes slowing (or even stopping) the host vehicle.

In the examples above, the trained model's indication of whether a scene or object falls outside of a predetermined “normal” sub-region of the embedding space may be based on analysis of a single input image. Additionally, however, a determination by the trained model of whether an object or scenario is anomalous may be based on a series of acquired images representative, for example, of an environment of a host vehicle over a particular time duration. For example, the model may be trained on sequences of images so that the trained network can identify anomalies developing over time (e.g., target vehicles on collision trajectories with a host vehicle, objects falling from a vehicle or at risk of falling from a vehicle, pedestrians walking along a road segment, a person signaling traffic with hand gestures, etc.). That is, the disclosed embodiments may include a trained model configured to encode a plurality of images (e.g., a stream of video frames) and use a predetermined sub-region in embedding space to detect temporal anomalies. Such models may be trained to populate the embedding space distribution according to what is normal both in terms of features alone and also based on what are normal evolutions of driving scenes etc.

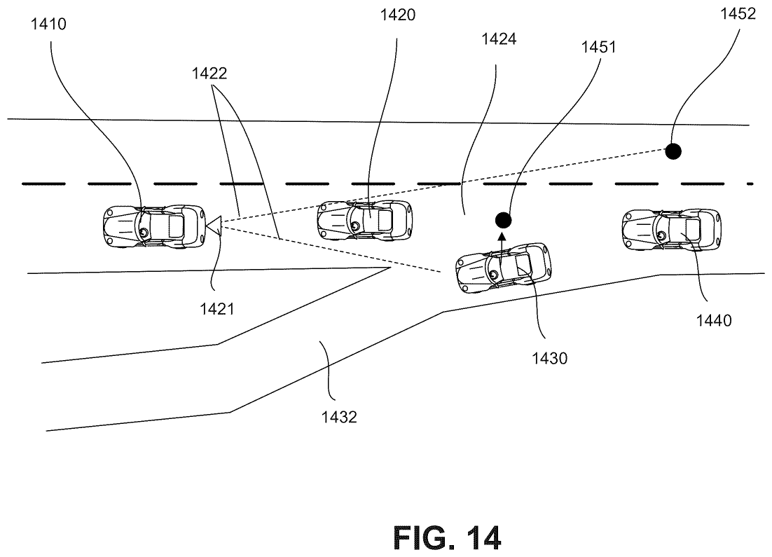

FIG. 14 represents another anomalous situation for which the disclosed embodiments may assist in determining an appropriate navigational response. In this example, the disclosed trained model may be provided with a plurality of captured images that represent the environment of host vehicle 1410 over a time period during which the images were captured. The trained model may return an indication, for each (or any) individual image frame, that a generated embedding associated with captured image falls outside of a predetermined “normal” embedding space sub-region. In addition, however, the trained model may also return an indication for any group of two or more images that an anomalous scenario has developed over time. For example, in the scenario represented by FIG. 14, host vehicle 1410 is navigating from left to right in the right lane of a section of highway. Host vehicle 1410 is following behind a target vehicle 1420. Host vehicle 1410 includes an onboard camera 1421, and target vehicle 1420 occupies a portion of the field of view of camera 1421, as indicated by sight lines 1422. As a result, there is an obscured region 1424 blocked by target vehicle 1420, such that images captured by camera 1421 will not include representations of objects residing in obscured region 1424.

In the scenario of FIG. 14, a second target vehicle 1440 travels in the right lane of the highway and directly in front of target vehicle 1420. A third target vehicle 1430 approaches the highway from an entrance ramp 1432 and navigates to a location 1451 within a gap ahead of target vehicle 1420 and behind target vehicle 1440. At a similar time, target vehicle 1440 changes from the right lane of the highway to the left lane of the highway and moves to a location 1452.

As a result of the motion of the target vehicles relative to camera 1421 and sight lines 1422, as target vehicle 1430 approaches along entrance ramp 1432, target vehicle 1430 will be visible to camera 1421 and represented in images captured by camera 1421. As part of a target vehicle identification and tracking process, the host vehicle navigation system of vehicle 1410 may assign a tracking id to target vehicle 1430. As target vehicle 1430 moves into region 1424, however, it becomes hidden from camera 1421 by target vehicle 1420. At near the same time, however, target vehicle 1440 moves from a location in region 1424 where it is not visible to camera 1421 to location 1452, where it becomes visible to camera 1421. Upon detection of vehicle 1440, the navigation system of vehicle 1410 may assign a tracking id to vehicle 1440. Because of the spatial proximity of vehicles 1430 and 1440, and in view of the closeness in time between when vehicle 1430 moves to location 1451 (out of sight of camera 1421) and when vehicle 1440 moves to location 1452 (within sight of camera 1421), there is a significant possibility that the host vehicle navigation system of vehicle 1410 will mis-identify vehicle 1440 as vehicle 1430 and assign the tracking id of vehicle 1430 to vehicle 1440. This can cause tracking issues, especially if vehicle 1430 later emerges from in front of vehicle 1420 and into view of camera 1421.

In this scenario, the trained model may return an indication that the scene evolution over a plurality of captured images frames constitutes a time-based anomaly. For example, embeddings associated with individually captured images and/or variations in the captured images occurring over a period of time may represent abnormalities such as mismatched trajectories, colors, body shape, etc. between vehicle 1430 and 1440. Such abnormalities may provide a basis for the trained model to return an indication that a time based non-normal scene evolution has occurred. In response, the host vehicle navigation system may re-acquire the target vehicle id before the erroneous vehicle id handoff event occurred and then forward track the visible target vehicle(s) and preclude the erroneous vehicle id shift that resulted in a detection of an anomalous event.

There may be many other uses for the disclosed embodiments. In some cases, the trained model may encode images captured from a camera facing inside of a vehicle. In such an example, generated embeddings and a predetermined “normal” sub-region of the embedding space may be used to detect whether anomalies exist relative to passengers or operators of an AV. For example, one or more cameras may be arranged to capture images representative of a driver, operator, or passenger, etc. of the host vehicle. The captured images may be provided to the described system, including the described trained neural network(s), and the trained neural network may return an indication of whether a face of the captured individual, or any other aspect of the interior of the host vehicle is determined to be abnormal. Such a condition may exist, for example, where a driver/operator is facing a proper direction, but the driver/operator's face shows signs of a health condition such as a stroke, heart attack, etc. or whether the driver/operator is asleep.

Among many other examples, the disclosed trained model may return an indication of an anomalous situation based on one or more captured images that include a representation of: a pedestrian standing on top of a target vehicle (wherein the determined navigational action may include changing a heading direction of the host vehicle or slowing of the host vehicle); or cargo attached to a top of a target vehicle (e.g., a flapping mattress or loose ladder) (wherein the determined navigational action may include changing a heading direction of the host vehicle or slowing of the host vehicle).

The disclosed embodiments may also return an indication of a normal object/scenario where an input image includes a representation of a recognized traffic sign type (e.g., a STOP sign, a YIELD sign, etc.) or a representation of an unrecognized traffic sign type (e.g., a newly instituted traffic sign), but where the unrecognized traffic sign is close enough in embedding space to be identified as not anomalous. As noted above, however, the disclosed trained model may return an indication of an anomalous object/scenario where a captured image includes a representation of a recognized traffic sign (e.g., a STOP sign), but where the recognized traffic sign includes graffiti markings.

Various types of actions may be taken in response to an indication of a detected anomalous object or scenario. For example, a host vehicle navigation system may use the output of the trained model as a trigger for a policy system to implement a navigational change (e.g., changing a heading direction of the vehicle, braking the host vehicle, etc.). Additionally or alternatively, the host vehicle navigation system may use the output of the trained model as a trigger for a policy system to change its mode of operation, for example, requiring greater safety distances or margins or requiring a driver to takeover. Additionally, an indicator of an abnormal condition (e.g., an overturned vehicle blocking a lane of a road segment) may trigger the host vehicle system to automatically report the detected anomaly and its location (e.g., using REM map drive information harvesting techniques and vehicle localization technology) to one or more authorities, traffic reporting systems, etc. The trained model may be useful for screening training data sets (e.g., to identify anomalous data) or for identifying anomalies that may exist in point clouds generated by LIDAR or RADAR systems, VIDAR depth maps (e.g., depth information generated by a trained model on a pixel by pixel basis for a captured image), etc. The trained model may be used to augment REM map drive information harvesting (e.g., by assisting a harvesting system in identifying anomalous objects or scenarios that can be excluded from harvested drive information used in generating a REM map).

The disclosed system may offer several potential benefits. For example, the described trained model may eliminate the need to train models on data sets including edge cases (of which there may be an infinite number). By training on data that represents objects/scenarios considered to be “normal,” the disclosed trained model may still properly identify anomalous objects/scenarios even where none of the training data used to train the model included examples of such anomalous objects/scenarios.

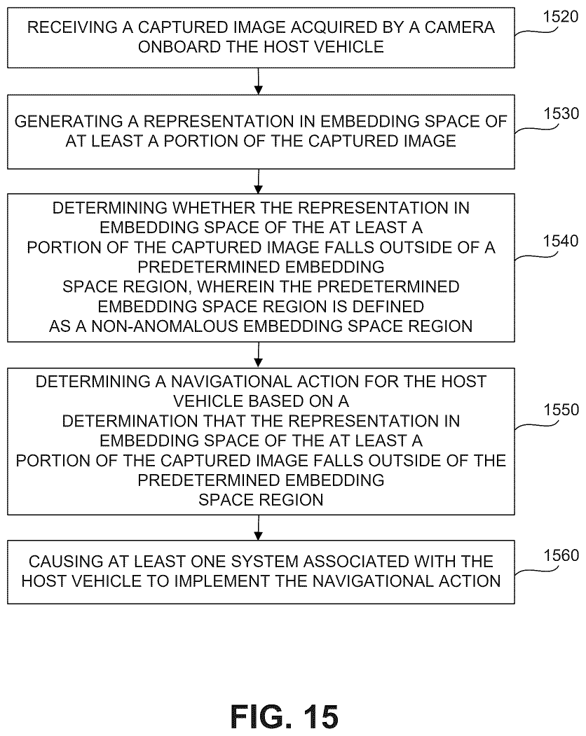

FIG. 15 represents an example method 1510 for navigating a host vehicle relative to a road segment. The method may include receiving a captured image acquired by a camera onboard the host vehicle (step 1520); generating a representation in embedding space of at least a portion of the captured image (step 1530); determining whether the representation in embedding space of the at least a portion of the captured image falls outside of a predetermined embedding space region, wherein the predetermined embedding space region is defined as a non-anomalous embedding space region (step 1540); determining a navigational action for the host vehicle based on a determination that the representation in embedding space of the at least a portion of the captured image falls outside of the predetermined embedding space region (step 1550); and causing at least one system associated with the host vehicle to implement the navigational action (step 1560).

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for navigating a host vehicle relative to a road segment, the system comprising:
at least one processor comprising circuitry and a memory, wherein the memory includes instructions that when executed by the circuitry cause the at least one processor to:
receive a captured image acquired by a camera onboard the host vehicle;
generate a representation in embedding space of at least a portion of the captured image;
determine whether the representation in embedding space of the at least a portion of the captured image falls outside of a predetermined embedding space region, wherein the predetermined embedding space region is defined as a non-anomalous embedding space region;
determine a navigational action for the host vehicle based on a determination that the representation in embedding space of the at least a portion of the captured image falls outside of the predetermined embedding space region; and
cause at least one system associated with the host vehicle to implement the navigational action.

2. The system of claim 1, wherein the representation in embedding space of the at least a portion of the captured image is performed by a trained model.

3. The system of claim 2, wherein the trained model is a variational autoencoder.

4. The system of claim 2, wherein the trained model is further configured to output an indicator of whether the representation in embedding space of the at least a portion of the captured image falls outside of the predetermined embedding space region, and wherein the determination of the navigational action for the host vehicle is based the output of the trained model.

5. The system of claim 1, wherein generation of the representation in embedding space is performed by a trained model configured to map the at least a portion of the captured image to a probability distribution over latent variables associated with the embedding space.

6. The system of claim 1, wherein the predetermined embedding space region corresponds to a predetermined sub-region of a probabilistic distribution.

7. The system of claim 6, wherein the probabilistic distribution is a gaussian distribution.

8. The system of claim 6, wherein the predetermined sub-region is defined by at least one user-selectable parameter value.

9. The system of claim 8, wherein the at least one user-selectable parameter value includes a percentage value associated with the probabilistic distribution.

10. The system of claim 1, wherein the predetermined embedding space region is defined by an embedding space distance relative to an embedding space reference.

11. The system of claim 10, wherein the embedding space reference corresponds to an embedding space origin.

12. The system of claim 1, wherein the representation in embedding space includes at least one feature vector.

13. The system of claim 1, wherein the at least a portion of the captured image includes a representation of a road sign.

14. The system of claim 1, wherein the at least a portion of the captured image includes a representation of a target vehicle.

15. The system of claim 1, wherein the navigational action includes generating a visual or audible alert.

16. The system of claim 1, wherein the navigational action includes changing a heading direction of the host vehicle.

17. The system of claim 1, wherein the navigational action includes slowing the host vehicle.

18. The system of claim 1, wherein the navigational action includes maintaining a speed and heading direction for the host vehicle.

19. The system of claim 1, wherein the at least a portion of the captured image includes a representation of a first target vehicle being carried as cargo by a second target vehicle, wherein the first target vehicle and the second target vehicle are facing opposite directions, and wherein the determined navigational action includes maintaining a speed and heading for the host vehicle.

20. The system of claim 1, wherein the at least a portion of the captured image includes a representation of a pedestrian standing on top of a target vehicle, and wherein the determined navigational action includes changing a heading direction of the host vehicle or slowing of the host vehicle.

21. The system of claim 1, wherein the at least a portion of the captured image includes a representation of cargo attached to a top of a target vehicle, and wherein the determined navigational action includes changing a heading direction of the host vehicle or slowing of the host vehicle.

22. A method for navigating a host vehicle relative to a road segment, comprising:
receive a captured image acquired by a camera onboard the host vehicle;
generate a representation in embedding space of at least a portion of the captured image;
determine whether the representation in embedding space of the at least a portion of the captured image falls outside of a predetermined embedding space region, wherein the predetermined embedding space region is defined as a non-anomalous embedding space region;
determine a navigational action for the host vehicle based on a determination that the representation in embedding space of the at least a portion of the captured image falls outside of the predetermined embedding space region; and
cause at least one system associated with the host vehicle to implement the navigational action.
